(19) United States
(12) Patent Application Publication
(10) Pub. No.: US 2026/0336302 A1
(43) Pub. Date: Oct. 29, 2026

(54) Filter for Ink

(71) Applicant: Linx Printing Technologies Limited, St Ives (GB)

(72) Inventors: Stephen Eric Baldwin, St. Ives (GB); Simon Peter Jason Newell, St. Ives (GB)

(21) Appl. No.: 19/113,519

(22) PCT Filed: Sep. 19, 2023
(86) PCT No.: PCT/GB2023/052419

§ 371 Date: Mar. 20, 2025

(30) Foreign Application Priority Data
Sep. 20, 2022 (GB) 2213745.9

(51) Int. Cl. B41J 2/175

(52) U.S. Cl. CPC B41J 2/17563

(57) ABSTRACT

A filter module for filtering ink. The filter module comprising: a filter housing defining: a filter chamber; an inlet port; a first outlet port; and a second outlet port. The filter module further comprising a first filter element, comprising a first filter media, disposed in the filter chamber. The filter housing is configured to define a first filtrate path from the inlet port to the first outlet port via the first filter element, and a second path from the first inlet port across an outer surface of the first filter element to the second outlet port. When in use, the first outlet port and the second outlet port are arranged vertically above the inlet port.

The present invention relates to inkjet printing and more particularly to an ink filter for filtering ink. The ink filter may be for use with pigmented ink in an inkjet printer, such as a continuous inkjet printer.

In inkjet printing systems the print is made up of individual droplets of ink generated at a nozzle and propelled towards a substrate. There are two principal systems: drop on demand where ink droplets for printing are generated as and when required; and continuous inkjet printing in which the droplets are continuously produced and only selected ones are directed towards the substrate, the others being recirculated to an ink supply.

Continuous inkjet printers supply pressurised ink to a print head drop generator where a continuous jet or stream of ink emanating from a nozzle is stimulated to form individual regular drops by, for example, an oscillating piezoelectric element. The drops are directed past a charge electrode where they are selectively and separately given a predetermined charge before passing through a transverse electric field, which may be provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically, the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate).

In continuous inkjet printing a character may be printed from a matrix comprising a regular array of potential drop positions. Each matrix comprises a plurality of columns (strokes), each being defined by a line comprising a plurality of potential drop positions (e.g. seven) determined by the charge applied to the drops, and various other influencing factors. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a ink storage tank of the ink supply system via a filter and delivers it under pressure to the print head. As ink is consumed the tank is refilled as necessary from a replaceable ink cartridge that is releasably connected to the tank by a supply conduit. The ink is fed from the tank via a flexible delivery conduit to the print head. The unused ink drops captured by the gutter are recirculated to the tank via a return conduit by a pump. The flow of ink in each of the conduits is generally controlled by solenoid valves and/or other like components.

Reliable droplet generation (by jet break-up) is contingent on the ink having substantially inviscid properties, so ink in the ink tank is preferably dilute. Ink recirculating from the gutter is solvent-depleted due to evaporation of solvent. Therefore, the ink (storage) tank has its mixture continually adjusted with make-up solvent from a replaceable solvent cartridge to ensure that the ink being drawn from the ink tank has an acceptable viscosity. Various types of inks maybe used within the continuous inkjet printers. The ink may include an organic solvent selected from C₁-C₄ alcohols, C₄-C₈ ethers, C₃-C₆ ketones, C₃-C₆ esters, and mixtures thereof. Inks may contain different types of colourant. In some circumstances dye based inks are used. This may typically be the case where the substrate onto which printing is performed is relatively light in colour such that light reflected from the surface on which printing is to be performed is coloured by the dye contained within the ink resulting in a pattern visible to the user. On the other hand, where a surface on which printing is conducted is dark in colour, and therefore does not reflect much light, pigmented inks maybe preferred. In such circumstances, the pigment contained within the ink may reflect certain colours of light, thereby ensuring that the printed image can be seen by a user. Of course, dye based, and pigmented inks may both be used for printing on some substrates, while pigmented inks may be used on light surfaces and, dye-based inks may be used on dark surfaces. One particular subgroup of pigmented inks is known as the hard pigmented inks. The pigment in these inks is typically a fine particulate of high hardness such as titanium dioxide, resulting in printed marks of high opacity.

Where pigmented inks are used, the ink consists of a suspension of colourant (i.e. pigment) particles within a solvent. Various other components or additives (e.g. surfactants or dispersants) may also be included within the composition of the ink. The ink composition may vary depending upon various characteristics, such as the colour required, the surface onto which printing is to be performed, solvents which are suitable for a particular application environment, and many other factors.

Filters within the printer are operated continuously when the printer is in use. In many continuous inkjet printers, a Venturi pump is used to generate suction. Such a pump typically operates with a continuous ink flow rate that far exceeds the flow rate of ink supplied to the printhead. In many cases, the entire ink flow is filtered by a main filter, having a fine (e.g. 10 μm) rating, in spite of only a small portion of the flow reaching the print nozzle. In such an arrangement, the high volume of ink filtered can lead to a higher rate of filter wear than is necessary. Fine particles (or pigment, or other debris) can gradually cause filters to become blocked. Further, the settling of pigment particles under the influence of gravity, can cause pigment to collect on filter surfaces, further contributing to filter performance degradation.

It is an object of the present invention, among others, to provide an improved ink filter for use with an inkjet printer (such as a continuous inkjet printer) which solves one or more problems, whether identified above or otherwise of using pigmented inks, inks containing precipitates and/or solid deposits.

According to a first aspect disclosed herein there is provided a filter module for filtering ink. The filter module comprising, a filter housing defining: a filter chamber; an inlet port; a first outlet port; and a second outlet port. The filter module comprising a first filter element, comprising a first filter media, disposed in the filter chamber. The filter housing is configured to define a first filtrate path from the inlet port to the first outlet port via the first filter element, and a second path from the first inlet port across an outer surface of the first filter element to the second outlet port; and when in use, the first outlet port and the second outlet port are arranged vertically above the inlet port.

The first filtrate path may be referred to as “through-flow” path (with reference to the first, or main, filter media). That is, the filtrate has flowed through, and thus been filtered by, the first filter media.

The second path may be referred to as a “cross-flow” path (again, with reference to the first, or main, filter media). That is, the portion of fluid flowing from the inlet along the second path has flowed across a surface of the first filter media, but has not necessarily been filtered by the first filter media.

The filter may be for filtering pigmented ink. In particular, the filter may be for hard pigmented ink. The filter may be for use in a continuous inkjet printer.

The first outlet port may be configured to provide fluid communication to a print head. By arranging a filter whereby ink can pass through a first filter element with a particular absolute rating, there is no need to filter all of the ink to a purity that is required for use in a printhead. Instead, only the volume of ink that needs to be supplied to a print head is filtered to a desired filtration level. The remaining ink can pass through the filter module so as to provide a constant washing effect, and possible also pass through a filter with a different (e.g. lower) absolute rating (e.g. a coarser filter).

The provision of an inlet port, and first and second outlet ports on a filter module allows for the filter to be emptied on shutdown, mitigating against sediment settling in the first and/or second filter elements (where present).

These features may increase the longevity of the first filter element and the second filter element.

The filter module may be referred to as a cross-flow filter. Advantageously, a higher flow rate of ink may pass through the filter chamber than would occur if only the flow that is traversing to a print head was flowing into the filter chamber. This is particularly advantageous as the likelihood of any sediment in the ink settling in the first filter element is reduced. The filter housing may be sized dependent upon printer requirements to alter the desired flow rates along the first filtrate path and second path (i.e. the through-flow rate and cross-flow rate).

The first outlet port and the second outlet port are spaced apart, in a vertical direction, from the inlet port, and are provided at a higher position on the filter housing, when it is installed for use. Thus, when in use in a printer, the filter module may be provided such that ink is pumped in a direction that comprises a vertically upwards component from the inlet to the first and second outlet ports. In other words, ink may be pumped through the filter in a direction that is opposite to the direction that gravity acts in. The flow of the ink via each of the first filtrate path and second path may therefore be in a generally upwards direction. Advantageously, this reduces the likelihood of sediment settling in the filter.

The filter module may further comprise a second filter element comprising a second filter media disposed in the filter housing, the second path may be a second filtrate path from the inlet port to the second outlet port via the second filter media.

Providing the first filter element and the second filter element in a single filter housing, allows for simple replacement of the filter, reducing downtime of a printing system.

The second filter element may be provided in the filter housing. The second filter element may be received in a portion of the filter housing that defines at least part of the second outlet port.

The first filter element may have a first absolute rating, and the second filter element may have a second absolute rating different to the first absolute rating.

The second absolute rating allows ink flowing along the second filtrate path to be filtered at a courser level than the first filtrate path.

The filter housing may be configured to define a third filtrate path from the inlet port to the second outlet port via the first filter media.

The third filtrate path may pass through the first filter element for a first time to a central cavity surrounded by the first filter element, and then pass through the first filter element for a second time to an outer cavity surrounding the first filter element.

The passage of filtrate through the first filter element for a second time to the outer cavity surrounding the first filter element causes the first filter element to be “back-washed”. That is, the flow of filtrate in a direction which is opposite to the first filtrate path reduces the extent to which filtered particles are retained by the first filter media.

Back-washing of the first filter element is particularly advantageous, when filtering pigmented ink, and more so when filtering hard pigmented ink. This is because, if the flow rate of ink through the first filter element is too low, pigment in the ink may sediment (i.e. deposit) within the first filter element. Sedimentation of pigment may occur while the filter is in use (i.e. when ink is being actively pumped through the filter), but increased rates of sedimentation may occur, for example, when emptying the filter during shutdown of a printing system, or if the printer is shutdown without emptying the filter. Sedimentation of pigment is undesirable as it causes the filter element to become blocked, and reduces the lifetime of the filter. The third filtrate path, which causes the first filter element to be backwashed mitigates against sedimentation of pigment in the first filter element, thus aiding in increasing the lifetime of the first filter element.

In use, only a relatively small flow rate of ink is required along the first filtrate path, where ink may be subsequently delivered to a print head. However, as the flow rate of the first filtrate path gets smaller, the likelihood of sedimentation of pigment in the first filter element increases. Therefore, another advantage of providing the third filtrate path is that the flow rate of the first filtrate path can be reduced without resulting in increased sedimentation of pigment. Put another way, by providing the third filtrate path, the cross sectional area of the first filter element can be increased, which allows for a desirable small flow rate along the first filtrate path, while mitigating against undesirable sedimentation. Accordingly, not only can a desirable flow rate of ink along the first filtrate path be achieved but the lifetime of the filter is also increased.

The third filtrate path may be referred to as a “counter-flow” path (again, with reference to the first, or main, filter media). That is, the filtrate has flowed through the first filter a first time, before flowing back through the first filter in a reverse flow direction.

Where a second filter is present, the third filtrate path may pass through the first filter media before the second filter media.

In use, the filter may be arranged to cause ink to flow in a generally upwards direction from the inlet to the first and second outlet ports.

Flowing in a generally upwards direction encompasses ink flowing in a direction that comprises a vertical component. In other words, the flow direction of ink comprises a component that is in the opposite direction to gravity. The flow of the ink through the main chamber may therefore be in a generally upwards direction. Advantageously, this reduces the likelihood of sediment settling in the filter. Causing ink to flow in an upwards direction is advantageous following shutdown, and emptying of the filter during shutdown. Emptying the filter on shutdown, reduces settling of sediment and pigment, nevertheless some resin may deposit on the surfaces of the pleat material of the first filter element which may block the filter. When ink is resupplied to the filter the settled resin is washed back into suspension in the ink, and does not block the first filter element.

The first outlet port and the second outlet port may be vertically separated.

In use, the second outlet port may be arranged vertically above the first outlet port.

Providing the second outlet port vertically above the first outlet port encompasses providing the second outlet port directly vertically above in the first outlet port, and providing the second outlet port in a region of the filter housing that is spaced vertically above the first outlet port but not necessarily lying in the same plane. Put another way, the inlet port, the first outlet port, and the second outlet port may each define a centroid, the vertical distance between the centroid of the inlet port and the centroid of the second outlet port may be greater than the vertical distance between the centroid of the inlet port and the centroid of the first outlet port. As such, in use, more work must be done against the force of gravity to pump ink to the second outlet port compared to pumping ink to the first outlet port.

Providing the second outlet port vertically above the first outlet port, in use, is advantageous because air in the chamber can exit the filter housing via the second outlet port, instead of through the first outlet port which may be connected to a printhead. As such, air bubbles which may become trapped in the filter housing can be readily removed without passing to a print nozzle.

Providing the second outlet port vertically above the first outlet port may be further advantageous since it will cause ink flowing to the second outlet port to flow around or through the first filter element, increasing the effective flow rate experienced by the first filter element, thereby reducing the rate of sedimentation.

In use, flow of ink along the first filtrate path may be in a direction generally opposite to the direction that gravity acts.

In use, flow of ink along the second path may be in a direction generally opposite to the direction that gravity acts.

The second path may comprise a path defined between an outer surface of the first filter element, and a wall of the filter housing defining the chamber.

The second (filtrate) path may surround an outermost surface of the first filter element. By surrounding an outermost surface, it is meant that the second filtrate path may, for example, surround a side wall of the first filter element, and is not limited to surrounding all surfaces of the first filter element. That is to say, that ink flowing to the second outlet port may pass across an outermost surface of the first filter element. An outermost surface, may be for example a side wall of the filter element. This enables a small flow rate of ink through the first filter element, which is desirable for feeding ink to a print nozzle via the first outlet port, compared to the flow rate of ink through the second filter element, while maintaining the flow rate of ink along the second flow path at a high enough rate to mitigate against sediment and ink pigment settling in the filter.

The first filter element may comprise a first end, and a second end opposing the first end. The first end and the second end may comprise first and second closures respectively. Such an arrangement promotes ink flowing over the entire external surface area of the first filter element. The first filter element may define a side wall which extends between the first and the second ends.

The first filter element may comprise an outlet port engagement arrangement to facilitate the flow of ink to the first outlet port.

### The Absolute Rating of the Second Filter Media May Be Greater Than the Absolute Rating of

the first filter element.

The effective surface area of the first filter element may be greater than the effective surface area of the second filter element.

The term effective surface area encompasses the total area of the filter media exposed to the flow of fluid that is usable for filtration. Such an effective area may be significantly larger than the geometric surface area of the filter media where a depth filter is used (e.g. a foam, multi-layer filter, or random fibre filter).

The first filter media may be a pleated filter media.

The first filter element may comprise a pleat protection filter, at least partially covering the pleated filter media.

The pleated filter media may be formed from polypropylene. The pleat protection filter may be formed from a material, such as stainless steel, that has a greater resistance to chemical ink attack. The pleat protection filter may surround an outer surface of the pleated filter media. The presence of a pleat protection filter protects against degradation of the pleated media. In particular, the pleated filter media may degrade over time, and portions of the pleated filter material may become free from the bulk of the first filter media. The pleat protection filter may prevent any free portions of the pleated filter media from mixing with ink in the main chamber and/or being carried away from the first filter element.

The first filter element may comprise an output screen, disposed between the pleated filter media and the first output port.

The output screen may prevent portions of the pleated filter material from passing to the first output port. The output screen may comprise a stainless steel mesh.

The absolute rating of the first filter element may be defined by the output screen.

The first filter element may define a central cavity, and the first filter element may comprise a central supporting structure, the central supporting structure may be disposed within the central cavity.

A nominal rating of the first filter element may be defined by the pleated filter media.

That is the nominal performance of the first filter element may be principally determined by the pleated filter media, rather than any pleat protection filter or other supporting structure.

Alternatively, or additionally, the absolute rating of the first filter element may be defined by the pleated filter media.

The second filter media may comprise a mesh filter. The second filter media may be formed from stainless steel or another suitable material. The nominal and/or absolute rating of the second filter media may be defined by the mesh filter.

The first filter media may comprise a stainless steel mesh filter media.

In particular, the stainless steel mesh filter medium may be a stainless steel depth filter. Advantageously, the number of components of the first filter element is minimised.

The first filter media may comprise a polypropylene mesh or a PTFE mesh.

The inlet port may be configured to be connected to an ink pump to pump ink along at least the first, second and third filtrate paths.

The pump may be arranged to cause a higher ink flow rate through the filter upon start-up. This promotes re-mixing of any sediment or resin that may have settled in the filter, in particular in or on the first filter element and/or the second filter element, and thus reduces blockages of the first and second filter elements.

The first filter element may be generally cylindrical.

Providing a first filter element with a cylindrical profile increases the surface area over which ink passes. Advantageously, the total flow rate of ink through the filter can be kept above a predetermined minimum rate, thereby reducing the likelihood of sediment settling in the first filter element, while also allowing for a desired flow rate of ink to pass from the inlet to the first outlet port.

The filter module may have a rounded shape (e.g. generally cylindrical, with rounded end faces).

The first outlet port, and the second outlet port may be arranged on a single face of the filter housing.

By providing all three fluid ports on a single face, it is possible to install and remove the filter module in a simple operation.

In use, the flow rate of ink through the second outlet port may be greater than the flow rate of ink through the first outlet port.

The relative flow rates may be defined as ink flow rates during printing operations, rather than during cleaning or maintenance operations. During printer operations, the flow rate of ink through the second outlet port may be at least twice the rate of flow of ink through the first outlet port.

The filter module may further comprise a presence detection feature configured to interact with a detector configured to detect when the filter is engaged with a printing system.

A suitable presence detection mechanism, or detector, may for example include a hall effect sensor. The presence detection feature may comprise a magnet. In particular, a magnet for use with a hall effect sensor may be provided on the filter housing. Other suitable presence detection mechanisms and motion sensors may be provided. The presence detection mechanism may be used to control operation of a pump and hence the flow on ink into the filter.

The filter module may further comprise a removal handle.

The removal handle may allow a user to grip the filter to apply a pulling force to allow easier removal of the filter from the printer.

The removal handle may comprise one or more apertures. The removal handle may comprise two apertures. The apertures may provide openings through which an operator can grip, and manipulate (e.g. remove) the filter module. The apertures, may therefore aid in installation and removal of the filter module by an operator.

The filter module may further comprise an engagement structure for engagement with a complementary structure of a printer to secure the filter module in an installed configuration.

Providing an engagement structure such as a handle-like feature may allow for the filter module to be securely engaged with a printer. Providing a secure engagement between the filter module and the printer mitigates against unintentional release or ejection of the filter module, for example when the filter module is placed under pressure caused by ink pumping through the filter module.

According to a second aspect of the invention, there is provided a filter module for filtering ink, the filter module comprising:
a filter housing defining:
   a filter chamber;
   an inlet port;
   a first outlet port; and
   a second outlet port;
a first filter element, comprising a first filter media, disposed in the filter chamber; wherein:
   the filter housing is configured to define a first filtrate path from the inlet port to the first outlet port via the first filter element, and a second path from the first inlet port across an outer surface of the first filter element to the second outlet port; and
   wherein the inlet port, the first outlet port, and the second outlet port are arranged on a single face of the filter housing; and
   when in use, the first outlet port and the second outlet port are arranged vertically above the inlet port.

Optional features of the first aspect of the invention may be combined with the second aspect of the invention, save as for where the optional feature is already present in the second aspect.

According to a third aspect of the invention there is provided a filter module for filtering ink, the filter module comprising:
a filter housing defining:
   a filter chamber;
   an inlet port;
   a first outlet port; and
   a second outlet port;
a first filter element, comprising a first filter media, disposed in the filter chamber, and a second filter element comprising a second filter media disposed in the filter housing;
wherein:
   the filter housing is configured to define a first filtrate path from the inlet port to the first outlet port via the first filter element, and a second path from the first inlet port across an outer surface of the first filter element to the second outlet port; and
   wherein the second path is a second filtrate path from the inlet port to the second outlet port via the second filter media; and
   when in use, the first outlet port and the second outlet port are arranged vertically above the inlet port.

Optional features of the first aspect of the invention may be combined with the third aspect of the invention, save as for where the optional feature is already present in the third aspect. The features of the third aspect may be combined with features of the first and/or second aspect of the invention.

According to a fourth aspect of the invention, there is provided a filter module for filtering ink, the filter module comprising:
a filter housing defining:
   a filter chamber;
   an inlet port;
   a first outlet port; and
   a second outlet port;
a first filter element, comprising a first pleated filter media, disposed in the filter chamber, and the first filter element further comprising an output screen, disposed between the pleated filter media and the first output port;
wherein:
   the filter housing is configured to define a first filtrate path from the inlet port to the first outlet port via the first filter element, and a second path from the first inlet port across an outer surface of the first filter element to the second outlet port; and
   when in use, the first outlet port and the second outlet port are arranged vertically above the inlet port.

Optional features of the first aspect of the invention may be combined with the fourth aspect of the invention, save as for where the optional feature is already present in the fourth aspect. The features of the fourth aspect may be combined with features of the first and/or second and/or third aspect of the invention.

According to a fifth aspect of the invention, there is provided a filter module for filtering ink, the filter module comprising:
a filter housing defining:
   a filter chamber;
   an inlet port;
   a first outlet port; and
   a second outlet port;
a generally cylindrical first filter element, comprising a first filter media, disposed in the filter chamber;
wherein:
   the filter housing is configured to define a first filtrate path from the inlet port to the first outlet port via the first filter element, and a second path from the first inlet port across an outer surface of the first filter element to the second outlet port; and
   when in use, the first outlet port and the second outlet port are arranged vertically above the inlet port.

Optional features of the first aspect of the invention may be combined with the fifth aspect of the invention, save as for where the optional feature is already present in the fifth aspect. The features of the fifth aspect may be combined with features of the first and/or second and/or third and/or fourth aspect of the invention.

The inlet port, the first outlet port, and the second outlet port of the third, fourth or fifth aspect may be arranged on a single face of the filter housing.

The filter module of the second, fourth, or fifth aspect may comprise a second filter element comprising a second filter media disposed in the filter housing, the second path may be a second filtrate path from the inlet port to the second outlet port via the second filter media.

The first filter media of the second, third or fifth aspect may be a pleated filter media, and the first filter element may comprise an output screen, disposed between the pleated filter media and the first output port.

The first filter element of the second, third, or fourth aspect may be generally cylindrical. According to a sixth aspect disclosed herein there is provided a continuous ink jet printer comprising an ink circuit, the ink circuit comprising an ink tank, an ink pump arrangement and a filter module for filtering ink according to the first, second, third, fourth, or fifth aspect of the invention; wherein the ink pump is configured to pump ink from the ink tank through the first inlet port to pass along at least one of the first filtrate path and second path.

In use, the filter module may be arranged to cause ink to be pumped in a generally upwards direction away from the inlet port.

That is to say, the filter is orientated in the printer such that the pump causes ink to be pumped through the filter in a direction that comprises a component which is in the opposite direction to what gravity acts.

The continuous inkjet printer may further comprise a pressure sensor, the pressure sensor may be configured to sense the pressure drop across the first filter element.

The continuous inkjet printer may further comprise a pressure sensor, the pressure sensor may be configured to sense the pressure drop across the second filter element. Sensing the pressure drop across the first filter element and/or the second filter element may be used to determine when the first and/or second filter elements need replacing. The change in pressure across the first filter element and/or second filter element may be collated against known or tested drops in pressure to determine when the first filter element and/or second filter element needs replacing or cleaning. The pressure drop may be measured during start-up of the printer or during shutdown of the printer. When the pressure drop reaches a predetermined value, this may be indicative that the first filter element and/or the second filter element requires replacement. The pressure sensor may be coupled to a controller, where the controller adjusts the ink pump rate dependent on the pressure.

According to a seventh aspect disclosed herein there is provided a filter housing for a filter module for filtering ink. The filter housing defining: a filter chamber; an inlet port; a first outlet port; and a second outlet port. Wherein, the filter chamber is configured to receive a first filter element; the filter housing is configured to define a first filtrate path from the inlet port to the first outlet port via the received first filter element, and a second path from the first inlet port across an outer surface of the received first filter element to the second outlet port; and when in use, the first outlet port and the second outlet port are arranged vertically above the inlet port.

The filter housing may be configured to receive a second filter element.

The second outlet port may be configured to receive at least part of a second filter element.

The filter housing may be formed from at least two parts.

The two parts of the filter housing may be joined by spin welding.

The first outlet port and the second outlet port may be vertically separated from the inlet port when the filter is installed in a printer. The second outlet port may be vertically separated from the first outlet port when the filter is installed in a printer. The inlet port, the first outlet port and the second outlet port may be arranged on a single face of the filter housing.

According to a eighth aspect disclosed herein, there is a provided a method of manufacturing a filter module for filtering ink according to the first, second, third, fourth, or fifth aspect of the invention. The method comprising: placing a second filter element comprising a second filter media having a second absolute rating in a second outlet port defined by a filter housing, the filter housing further defining an inlet port, a first outlet port, and a filter camber; and placing a first filter element, comprising a first filter media having a first absolute rating, in the filter chamber.

The first absolute rating may be different to the second absolute rating.

The method may further comprise forming the first filter element. The forming including: forming a pleated filter media with a central cavity; securing a first closure on to a first end of the filter media; and securing a second closure onto a second end of the filter media, which opposes the first end.

Prior to securing the first and second closures, the method may comprise: disposing in the central cavity, a central supporting structure; and surrounding an outer face of the pleated filter medium with a pleat protection filter.

The method may further comprise thermally welding the first closure and the second closure to pleated filter media.

The first filter element may comprise an outlet port engagement arrangement and placing the first filter element in the main chamber may include engaging the engagement arrangement with the first outlet port.

The method may further comprise, after placing the first filter element in the filter chamber, joining two parts of the filter housing together by spin welding.

The method may comprise: pumping ink into a filter chamber defined by a filter housing via an inlet port; filtering, by a first filter element disposed in the filter chamber, a first portion of the ink flowing along a first filtrate path, the filtrate flowing out of the filter chamber via a first outlet port; causing a second portion of the ink to flow along a second path, the second path passing across an outer surface of the first filter element to a second outlet port; wherein, when flowing along the first filtrate path and the second path the flow direction of the ink may comprise a component that is in a direction that is opposite to gravity.

The method may further comprise filtering, by a second filter, the second portion of the ink.

Causing the second portion of the ink to flow along the second path may comprise the filtering by the second filter, the second filter being disposed in the second outlet port. Filtering, by the first filter element may comprise filtering the first portion of ink to remove particles above a first predetermined size; and filtering, by the second filter element may comprise filtering the second portion of ink to remove particles above a second predetermined size, the second predetermined size may be greater than the first predetermined size.

That is, the second filter may have a larger nominal rating and/or absolute rating than the first filter element.

According to a ninth aspect disclosed herein there is provided a method of operating a continuous inkjet printer comprising the method of filtering ink according to the eighth aspect of the invention. The method further comprising pumping the first portion of the ink from the first outlet port to a printhead of the continuous inkjet printer.

The method may further comprise pumping the second portion of the ink from the second outlet port to a Venturi pump.

The method may further comprise pumping the second portion of the ink from the second outlet port to an ink tank of the continuous inkjet printer.

According to a tenth aspect disclosed herein there is provided a filter module retention mechanism for retaining a filter module for a continuous inkjet printer, comprising: a first support; and a second support pivotally connected to the first support. The filter module is receivable by at least one of the first and second supports in an unlocked configuration in which the second support is distal the first support. At least one of the first and second supports comprises a first retention feature configured to retain the filter module in a locked configuration in which the second support is proximate the first support, to retain the filter module; and at least one of the first and second supports comprises a second retention feature configured to latch the mechanism in the locked configuration and substantially prevent rotation of the second support relative to the first support.

Advantageously, the filter module retention mechanism securely retains the filter module in operation, by virtue of the first retention feature, but the filter module can be readily released by an operator, in order to access the filter module, by virtue of the second retention feature. Undesirable ejection of the filter module from the mechanism in use can therefore be avoided without requiring a significant removal effort by an operator in order to remove the filter module.

The first support may be described as a fixed support. The second support may be described as a moveable, or rotatable support. The second support may be pivotally connected to the first support directly, or there may be one or more other interposing components such that the second support be indirectly pivotally connected to the first support.

The filter module may be receivable by at least one of the first and second supports by virtue of engagement of ports of the filter module with corresponding ports of the first or second supports. One or more of the first and second supports may abut, or engage, the filter module, in order to receive the filter module. The filter module is preferably receivable by the second support.

The first retention feature may be described as a generally axially retaining feature insofar as the first retention feature substantially prevents outward ejection of the filter module in operation. The first retention feature may be described as a backstop or buffer. The first retention feature may actively engage (i.e. abut) the filter module when the filter module is in the locked configuration. The first retention feature may not actively engage (i.e. abut) the filter module when the filter module is in the locked configuration. The first retention feature may be engageable with the filter module in the locked configuration. The first retention feature may act to at least counteract the force exerted on the filter module by virtue of fluid being forced through the filter module in operation. The first retention feature may be described as anchoring the filter module in position. The first retention feature may take the form of a ledge or other abutting feature. The first retention feature may engage an upper (e.g. outer) surface of the filter module. The first retention feature may directly engage the filter module, or may indirectly engage the filter module by virtue of one or more other interposing components. The first retention feature may be described as limiting the travel of the filter module. The first retention feature may be described as preventing excessive movement of the filter module in an axial direction. The second support may be described as proximate the first support when the second support cannot rotate to be any closer to the first support.

The second retention feature may otherwise be described as a rotational latch. The second retention feature may be described as (rotationally) fixing the first and second supports in relation to one another. The second retention feature may be described as releasably securing the first and second supports in relation to one another. When in the locked configuration, rotation of the second support relative to the first support may be entirely prevented by the second retention feature. The second retention feature may engage the other of the first and second supports. Alternatively, or in combination, the second retention feature may be configured to engage the filter module itself.

The second retention feature may be a clip.

The clip may be described as undergoing elastic deformation in use as it is deflected by whichever feature it is engaging. The clip may engage the filter module (e.g. a projection of the filter module). Alternatively, the clip may engage the other of the first and second supports.

Advantageously, the clip provides a retention feature which can be readily released in operation. The clip preferably provides a retention force in a direction which is different to a direction in which the filter module is urged in operation.

The clip may comprise a tapered engagement surface.

The clip may otherwise be described as comprising a wedge-shaped surface. The tapered engagement surface is preferably narrowest at a (first) outer end, and increases in thickness moving away from the outer end towards a second end. The urging of a feature along the tapered engagement surface preferably elastically deforms the clip. The clip preferably comprises a recess in which the feature which is retained is received once the clip has been deformed by its greatest extent. The clip may therefore be described as a locking feature which, until the clip is deformed again, will remain in an at-rest position and rotationally latch the mechanism in the locked configuration.

The second retention feature may latch the mechanism in the locked configuration as the filter module retention mechanism transitions from the unlocked configuration to the locked configuration.

Advantageously, the second retention feature latching the mechanism in a locked configuration as the filter module retention mechanism transitions from the unlocked configuration to the locked configuration means that no manual intervention may be needed in order to achieve the latching. Described another way, the latching may be achieved purely by virtue of the movement of the first and second bodies relative to one another (e.g. be automatic).

The second retention feature may latch the mechanism in the locked configuration as the second support is rotated towards the first support.

The second retention feature may latch the mechanism in the locked configuration as the second support reaches a position whereby the second support is at its closest proximity to the first support. Described another way, the latching may occur at the end of travel of the second support. The second retention feature may latch the mechanism in the locked configuration as the second support is urged, or forced, towards the first support.

The first retention feature may comprise a ledge of the first support.

The ledge may otherwise be described as a surface of the first support. The ledge may be a flat surface of the first support. As the second support rotates, and with the filter module received by the second support, the ledge may act to urge the filter module towards the plurality of ports. When an upper surface of the filter module is engaged by the ledge, such that the retention mechanism provided in the locked configuration, the ledge may ensure the filter module is correctly received by the second support. The ledge may act as a buffer, or backstop, to prevent the filter module from disconnecting from the plurality of ports when the mechanism is in the locked configuration.

Advantageously, the ledge is a readily manufactured feature that provides the necessary limitation on the travel of the filter module to ensure the correct placement of the filter module.

The at least one of the first and second supports, by which the filter module is may be receivable, may further comprises a plurality of ports for connection to corresponding ports of the filter module.

The ports may otherwise be described as apertures. The ports may comprise inlet ports and outlet ports. The plurality of ports preferably comprises one inlet port and two outlet ports. The plurality of ports may comprise female connectors. Corresponding male connectors of the filter module may be received by the female connectors. The plurality of ports are preferably provided as part of the second support. In order to provide the rotation of the second support relative to the first support, the plurality of ports may be connected to the rest of the system (e.g. a printer) by flexible hoses. For example, the hoses may comprise PTFE.

Advantageously, the plurality of ports means that the filter module can be readily connected to the filter module retention mechanism and the wider system. Furthermore, the plurality of ports provide a convenient way of releasably engaging the filter module with the surrounding mechanism.

### The Plurality of Ports May Comprise a Plurality of Female Connectors.

At least two of the plurality of female connectors may have different axial lengths. Each of the plurality of female connectors may have different axial lengths. Described in another way, at least two of the plurality of female connectors may have different heights or axial extents.

In other embodiments the retention mechanism may comprise male connectors, and the filter module may comprise female connectors (i.e. the arrangement be reversed).

Advantageously, by providing female connectors with different axial lengths, as the filter module is removed from the filter module retention mechanism the various ports of the filter module will effectively disconnect from the corresponding female ports at different stages. This provides a gradual disconnection so that an operator can more readily predict when the filter module will become detached. This is in contrast to an arrangement where, for example, all of the connectors are the same size and so the disconnection occurs simultaneously (which makes it difficult to predict when the filter module will disconnect, risking an operator losing, or misplacing, the filter module).

In use, a retention force, exerted by the first retention feature, may be in a first direction, and wherein a retention force, exerted by the second retention feature, may be in a second direction different than the first direction.

The retention force exerted by the first retention feature may be described as acting against a force exerted on the filter module by fluid under high pressure as it passes through the filter module. The retention force exerted by the first retention feature may be described as acting parallel to an axis of the plurality of ports. The retention force exerted by the first retention feature may be described as generally axially retaining the filter module. The retention force exerted by the first retention feature may be described as a filter module retaining force. The retention force exerted by the first retention feature may act in a substantially linear direction. The retention force exerted by the first retention feature may act in a substantially horizontal direction in use. The first retention force may be described as exertable by the first retention feature.

The retention force exerted by the second retention feature may act in a generally rotational manner. Described another way, the retention force exerted by the second retention feature may act so as to substantially prevent the rotational separation of the first and second supports. The retention feature exerted by the second retention feature may be described as a latching force. The second direction in which the retention force exerted by the second retention feature is exerted may be about the axis of rotation defined between the first and second supports. The retention force exerted by the second retention feature may be configured to counteract an axial reaction force of the filter module generally wedging the first and second supports apart from one another. This maybe at least in part due to an arcuate, e.g. domed, upper surface of the filter module. The second retention force may be described as exertable by the second retention feature.

Advantageously, by having the first and second directions be different to one another, the force required to retain the filter module is effectively decoupled from the force required to latch the mechanism shut. The mechanism can therefore provide a relatively higher retention force of the filter module but which does not recover that high retention force to remove the filter module from the mechanism. This is advantageous in both ensuring that the filter module remains retained in use whilst also avoiding difficulties for an operator in periodically removing the filter module for maintenance.

The filter module may be receivable by one of the first and second supports in the unlocked configuration, and wherein the other of the first and second supports may comprise a sensor configured to detect the filter module in at least the locked configuration.

In the unlocked configuration the first and second supports may be said to define a filter module-receiving volume. In the locked configuration the first and second supports may be described as substantially enclosing the filter module.

It is preferably the first support which comprises the sensor configured to detect the filter module. The sensor preferably detects the filter module is both correctly received by the second support and that the second support is correctly oriented with respect to the first support in at least the locked configuration. The sensor maybe a magnet sensor such as a hall effect sensor. However, other varieties of sensor may otherwise be used.

Advantageously, the presence of a sensor to detect the filter module can ensure that the system is only able to operate when a filter module is correctly received. This may prevent inadvertent operation of the system where a filter module has erroneously either not been replaced or has not been installed correctly. The presence of the sensor may provide a failsafe system in which the system can only operate when the filter module is correctly installed.

The filter module retention mechanism may further comprise an ejection mechanism for ejecting the filter module from the filter module retention mechanism.

The ejection mechanism may comprise a lever. The ejection mechanism may comprise a screw. The ejection mechanism may act to provide an ejection force which acts on the filter module and which ejects the filter module from the filter module retention mechanism. The ejection mechanism may utilise mechanical advantage to reduce a force required by an operator to remove the filter module.

The ejection mechanism may be mounted on at least one of the first and second supports, preferably the second support. That is to say, the ejection mechanism is preferably at least partly mounted on a moveable, or rotatable, support. The ejection mechanism may comprise a pivot. The ejection mechanism may leverage against a rear of the filter module, and may leverage against the filter module proximate one or more of the plurality of ports. The ejection mechanism preferably provides an at least two times mechanical advantage multiplier increasing the force exerted by an operator to more readily eject the filter module from the retention mechanism.

Advantageously, the presence of the ejection mechanism makes it easier to remove the filter module from the mechanism periodically for reasons such as servicing.

The second support may be configured to receive the filter module in an unlocked configuration, and the first support may be a fixed support configured to retain the filter module in a locked configuration.

The second support being configured to receive the filter module in an unlocked configuration may otherwise be described as the second support being configured to receive the filter module when the second support is in a rotational position that is distal to the first support. Described another way, the second support is configured to receive the filter module when the retention mechanism is in an open configuration.

The first support being a fixed support is intended to mean that the first support does not move as the filter module retention mechanism is transitioned between an unlocked and a locked configuration. The retention mechanism may be secured, or mounted, to the overall printer by the first support.

The first support may be configured to directly engage the filter module. Alternatively, the first support may indirectly engage the filter module. In preferred embodiments, the first support may be configured to engage the filter module in a plurality of different locations in the locked configuration. For example, a ledge of the first support maybe configured to engage an upper surface of the filter module in the locked configuration, whilst a clip of the first support is configured to engage a projection of a filter module in the locked configuration (to rotationally latch the first and second supports with respect to one another).

The first support may comprise the second retention feature.

Described another way, the first support may comprise the clip.

According to an eleventh aspect disclosed herein there is provided an assembly for a continuous inkjet printer, comprising: the filter module retention mechanism according to the tenth aspect of the invention; and a filter module retained by the filter module retention mechanism.

Advantageously, when the filter module forms part of a continuous inkjet printer the filter module can be securely retained in position, to offset high forces exerted on the filter module by high pressure fluid pumped through the filter module, but can also be readily removed periodically for maintenance.

The second retention feature may engage a projection of the filter module in the locked configuration.

The projection of the filter module may otherwise be described as a handle of the filter module. The projection (e.g. handle) may be gripped by an operator when the filter module is inserted into the retention mechanism.

Advantageously, the projection can be readily located.

According to a twelfth aspect disclosed herein, there is provided a continuous inkjet printer comprising the assembly of the eleventh aspect of the invention.

According to a thirteenth aspect disclosed herein there is provided a method of securing a filter module in a filter module retention mechanism of a continuous inkjet printer, comprising: urging the filter module retention mechanism into an unlocked configuration in which a second support is distal a first support; placing the filter module in engagement with one of the first and second supports such that the filter module is received by the one of the first and second supports; urging the filter module retention mechanism into a locked configuration, in which the second support is proximate the first support, by rotating the second support towards the first support, and retaining the filter module by a first retention feature of one of the first and second supports, and engaging a second retention feature of one of the first and second supports to latch the mechanism in the locked configuration and substantially prevent rotation of the second support relative to the first support.

Urging the filter module retention mechanism into an unlocked configuration may comprise rotating the second support with respect to the first support. The first support may be rotated by up to around 20°to (rotationally) separate the second support from the first support and to provide a filter module-receiving volume.

Placing the filter module in engagement with one of the first and second supports preferably comprises placing the filter module in engagement with the second support. The filter module is therefore preferably received by the second support when the retention mechanism is in the unlocked configuration.

Urging the filter module retention mechanism into a locked configuration may comprise rotating the second support with respect to the first support. This is preferably by around 20 degrees. The second support being provided proximate the first support may otherwise be described as the retention mechanism substantially enclosing the filter module. The first retention feature of one of the first and second supports may engage the filter module, to retain the filter module, as the mechanism is urged into a locked configuration. Engaging a first retention feature of one or the first and second supports with the filter module to retain the filter module may comprise engaging a ledge of one of the first and second supports (preferably the first support) with the filter module (e.g. an upper surface of the filter module). This may provide the axial alignment of the filter module with respect to the plurality of ports. As the second support is rotated towards the first support, a first retention feature may at least partly cover, or overlap, the filter module (e.g. to limit the travel of the filter module). This may provide a backstop which prevents the filter module from moving past the first retention feature. Retaining the filter module by a first retention feature may comprise at least partly aligning a ledge with (e.g. over) the filter module. The ledge may be described as a buffer, or cap.

Engaging a second retention feature of one of the first and second supports may comprise a second retention feature engaging one or more of the filter module and the other of the first and second supports to rotationally lock the first and second supports with respect to one another. In preferred embodiments the second retention feature is a clip provided as part of the first support, and the clip engages the filter module (e.g. a projection thereof). The second retention feature is preferably engaged as the second support is rotated towards the first support. Described another way, the action of the rotation, or the urging operation, may automatically bias the clip such that the filter module engages the clip without an operator needing to manually actuate the clip.

Substantially preventing rotation of the second support relatively to the first support may comprise preventing rotation of the second support relative to the first support. Substantially preventing rotation may still allow a small degree of rotation but not enough that the filter module be able to be removed from the filter module-receiving volume defined by the retention mechanism. Described another way, the second support may be slightly rotatable relative to the first support, but not to such an extent that the filter module could be removed from the retention mechanism.

Advantageously, the method described above provides automatic retention of a filter module in a filter module retention mechanism which can securely retain the filter module whilst readily allowing an operator to remove the filter module where needed for maintenance. Furthermore, the first and second retention features preferably act to retain the filter module in different directions such that the force required by an operator to remove the filter module is less than the retention force needed to secure the filter module in use.

Placing the filter module in engagement with one of the first and second supports may comprise placing the filter module in engagement with the second support; and wherein urging the filter module retention mechanism into a locked configuration may comprise: aligning the first retention feature of the first support with the filter module to retain the filter module, and urging the second retention feature of the first support into engagement to latch the mechanism in the locked configuration.

Advantageously, urging the filter module retention mechanism into a locked configuration as described above both aligns the filter module with respect to the retention mechanism and then secures the retention mechanism in the locked configuration.

Placing the filter module in engagement with the second support may comprise inserting the filter module into a filter module-receiving volume defined by the second support. Placing the filter module into engagement with the second support may comprise inserting ports of the filter module into corresponding ports of the second support. The filter module may contact a support member of the second support as the filter module is placed into the second support.

The second retention feature may engage the filter module.

The second retention feature may be described as directly engaging the filter module. The second retention feature may engage a projection of the filter module.

The projection of the filter module which the second retention feature engages may be described as a handle of the filter module.

Engaging the projection of the filter module with the second retention feature may comprise urging a tapered engagement surface of a clip over the projection of the filter module to latch the mechanism in the locked configuration.

Advantageously, the tapered engagement surface of the clip may provide for an automatic retention of the filter module by the clip. Described another way, the clip may be elastically deformed by action of the second support rotating with respect to the first support such that an operator need not manually deform the clip. The retention operation is therefore made more straightforward as a result.

The method may further comprise detecting, via a sensor, that the filter module is correctly seated in at least the locked configuration.

The sensor maybe a magnet sensor, such a hall effect sensor. The sensor may detect that the filter module is correctly located in both the second support and the first support. Described another way, the sensor may be configured to detect that the filter module is correctly positioned in the retention mechanism. The sensor may be configured to detect that the filter module is aligned such that one or more ports of the filter module are in fluid communication with a corresponding one or more ports of the second support. The filter module may be used to provide a signal which indicates the filter module is correctly received in the locked configuration, and that the printer can therefore be operated. Similarly, the sensor may act to prevent operation of the printer unless the filter module is correctly seated in the locked configuration.

It will be appreciated that features described in the context of one aspect may be combined with other aspects described herein. For example, features described above in the context of a filter module may also be applied to continuous inkjet printer comprising such a filter module, or to a method of operation of such an inkjet printer, or to a method of manufacture of a filter module, or to a kit of parts. In particular, it will be appreciated that the filter module according to the first, second, third, fourth, or fifth aspect may be used with the continuous inkjet printer of the sixth aspect. Further the filter retention mechanism of the tenth aspect may be used with the filter module according to the first, second, third, fourth, or fifth aspect, the continuous inkjet printer of the sixth aspect, the filter housing of the seventh aspect, and the methods of the eighth or ninth aspects. The assembly of the eleventh aspect and the continuous inkjet printer of the twelfth aspect may be used with any of the first to tenth aspects.

Embodiments of the invention will now be described, by way of example only, with reference to the accompanying drawings in which:

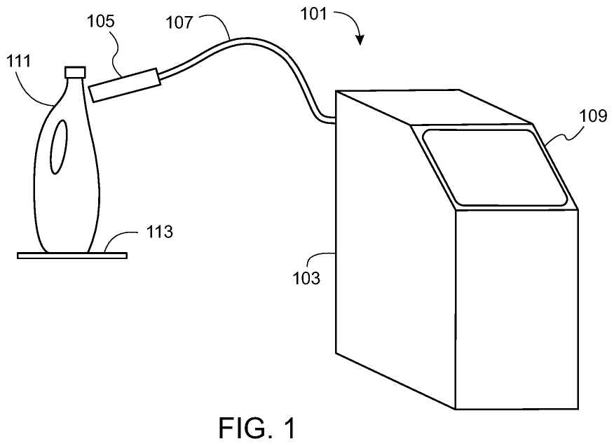

FIG. 1 schematically illustrates a continuous inkjet printer;

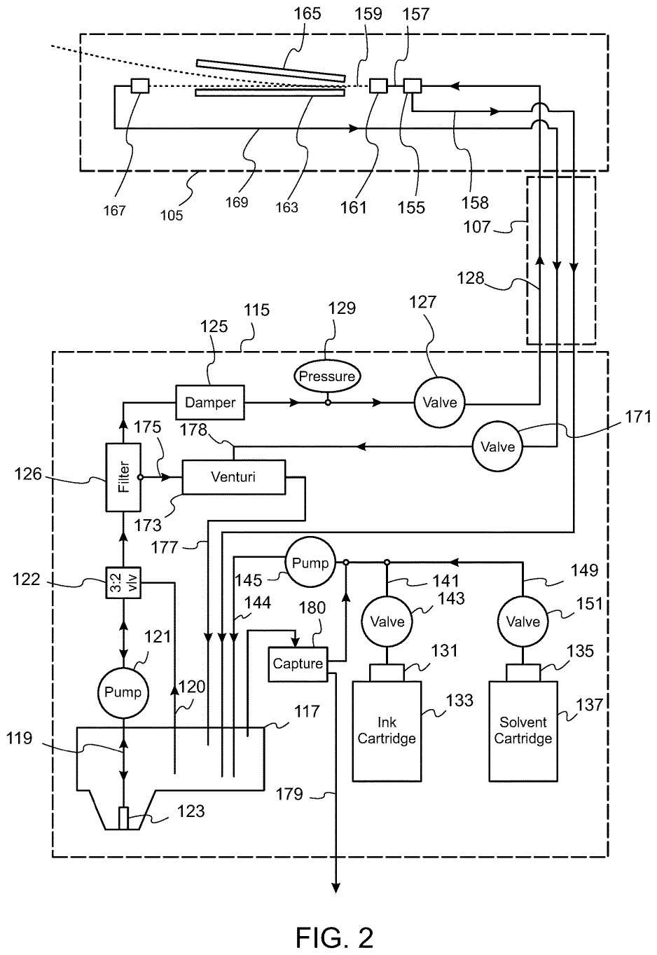

FIG. 2 schematically illustrates an ink circuit of the continuous inkjet printer shown in FIG. 1;

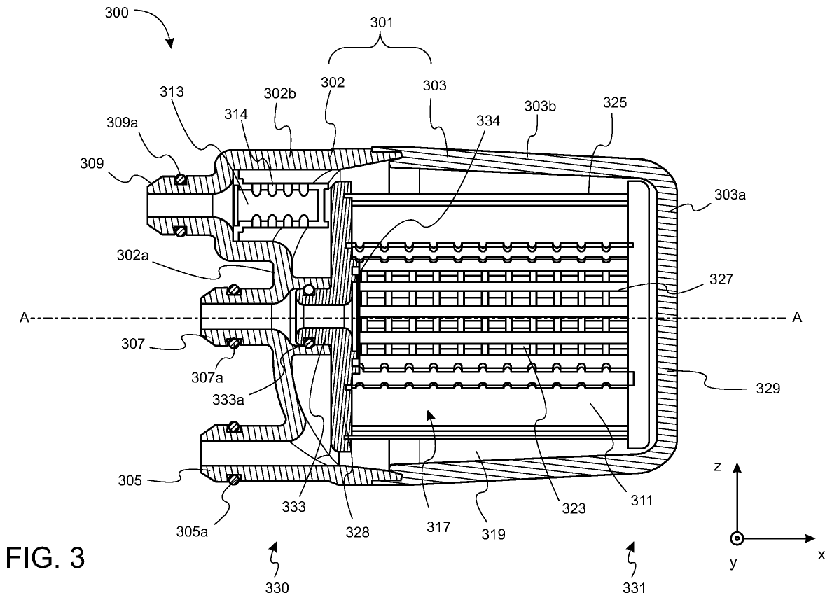

FIG. 3 schematically illustrates a cross section of an ink filter module for use in the continuous inkjet printer shown in FIG. 1;

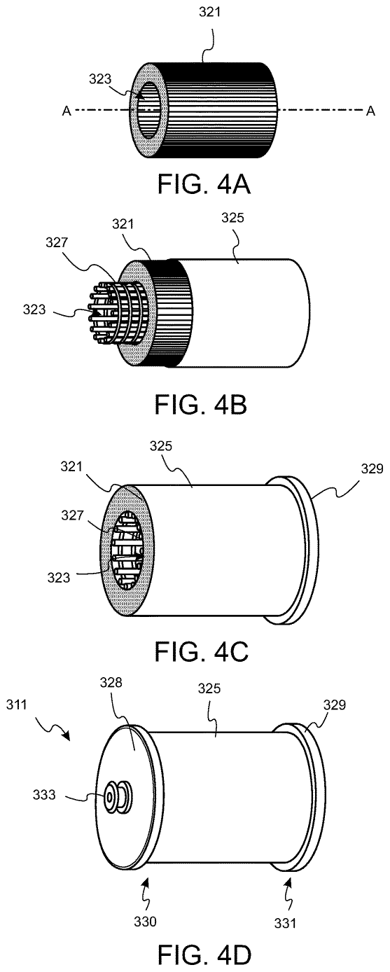

FIGS. 4A-4D schematically illustrate components of an ink filter element of the ink filter module shown in FIG. 3;

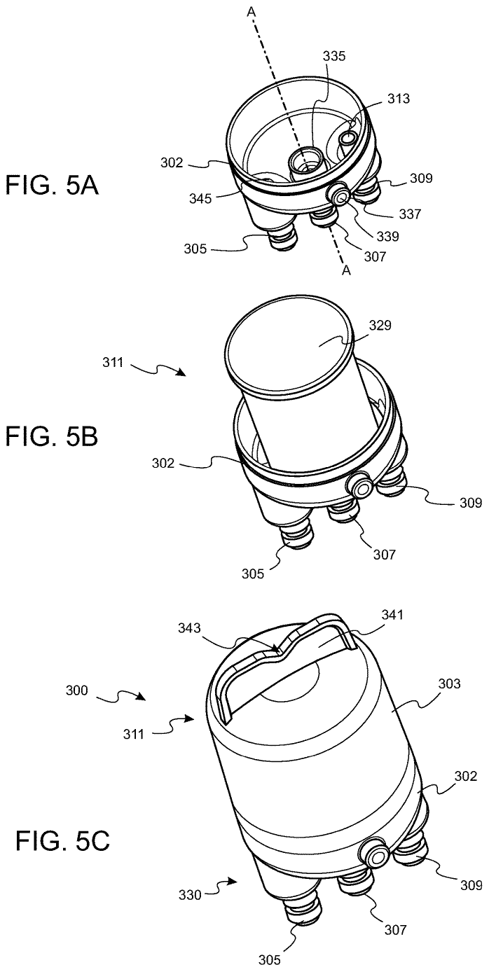

FIGS. 5A-5C schematically illustrate components of the ink filter module shown in FIG. 3;

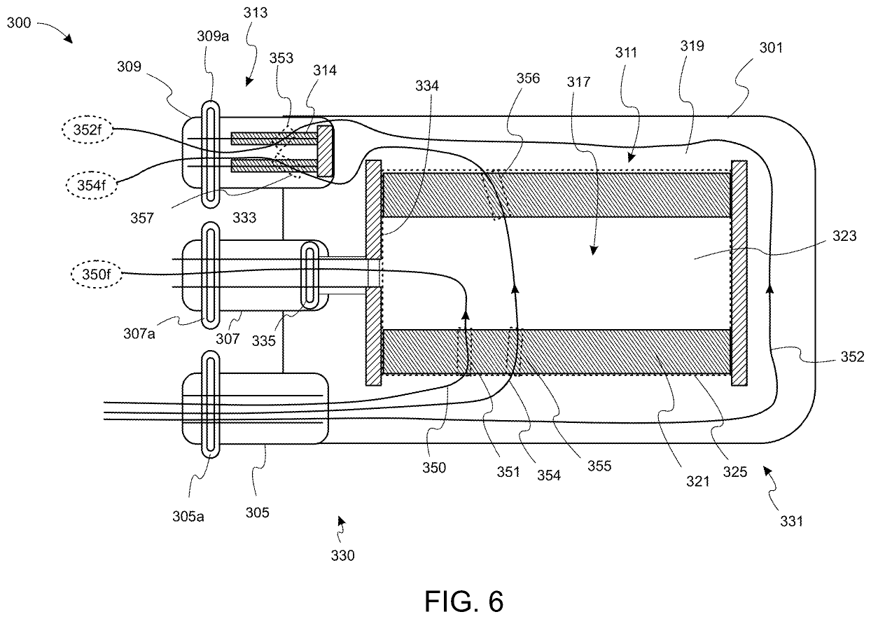

FIG. 6 schematically illustrates fluid flow paths within the ink filter module shown in FIG. 3;

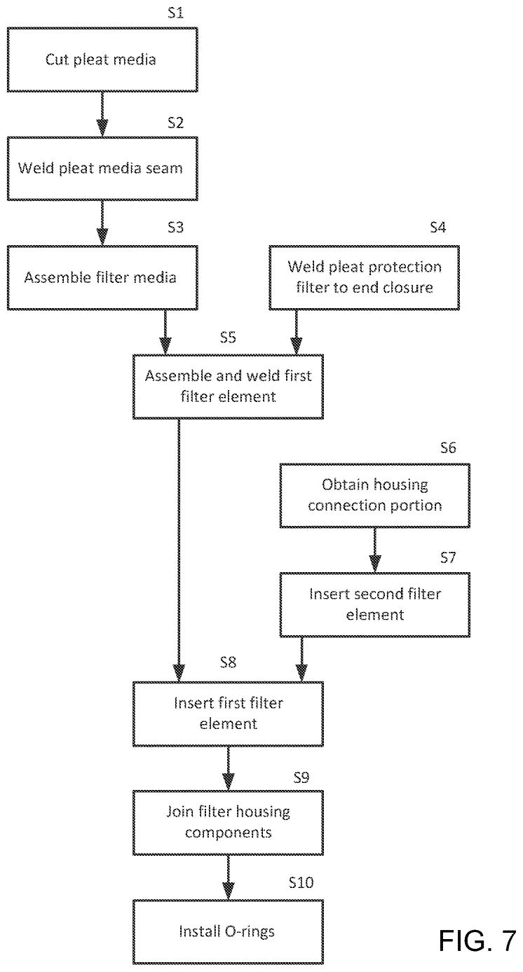

FIG. 7 illustrates a manufacturing process for the ink filter module shown in FIG. 3;

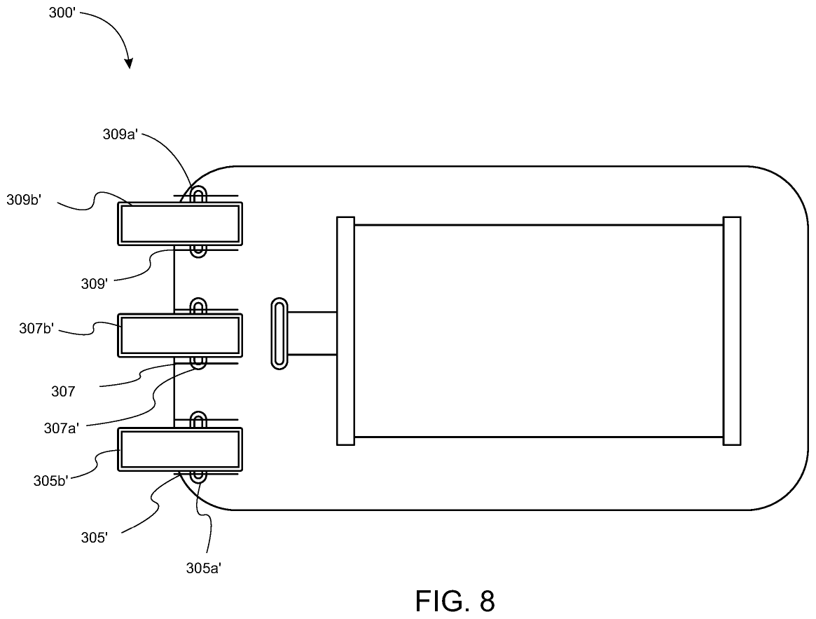

FIG. 8 schematically illustrates an ink filter module having an alternative port arrangement;

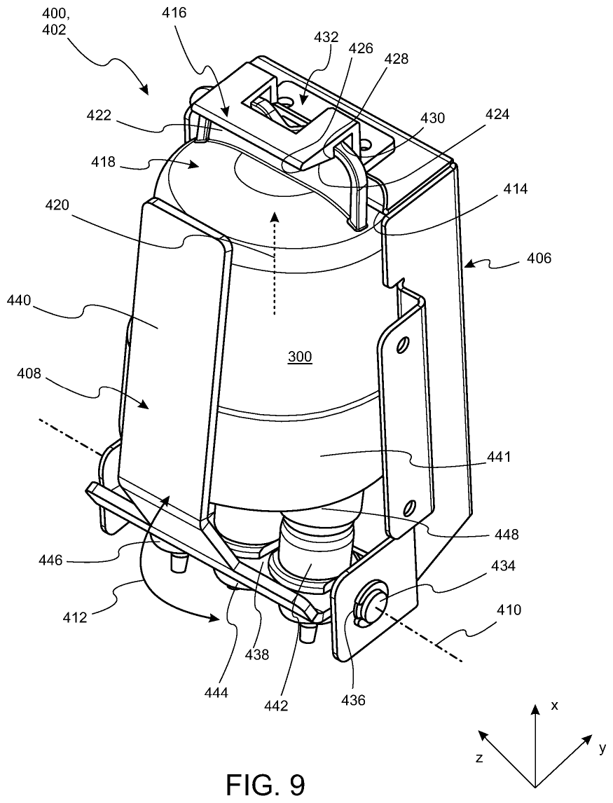

FIG. 9 is a perspective view of an assembly, shown in a locked configuration, comprising a filter module retention mechanism and a filter module according to another embodiment;

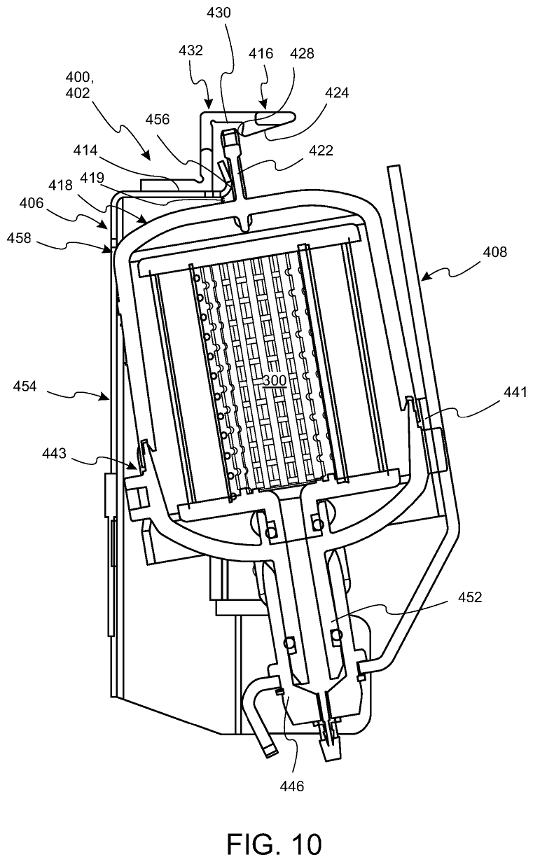

FIG. 10 is a cross-section side view of the assembly of FIG. 9;

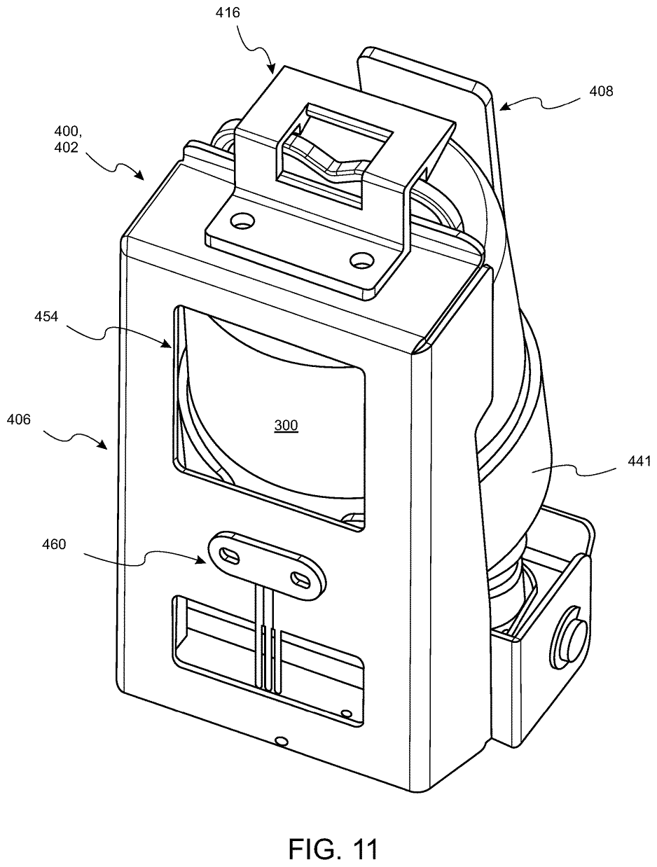

FIG. 11 is a rear view of the assembly shown in FIGS. 9 and 10;

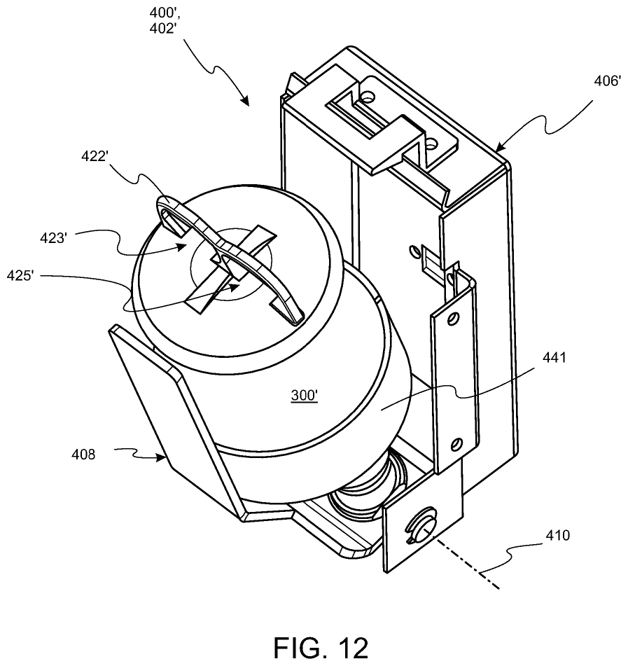

FIG. 12 is a perspective view of an assembly, shown in an unlocked configuration, according to another embodiment; and

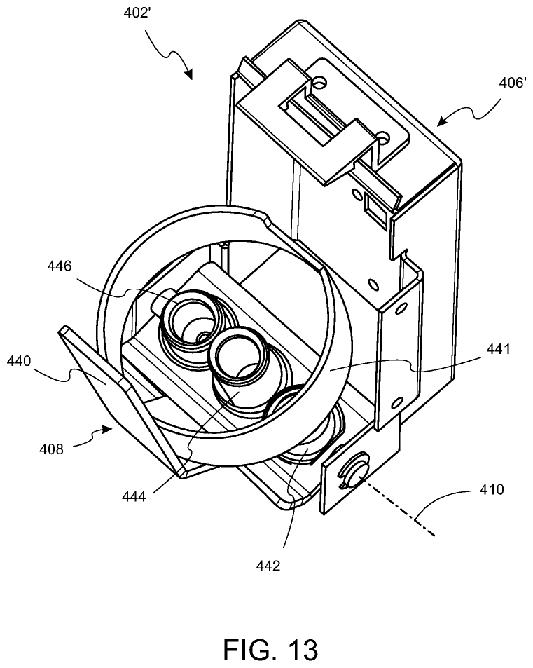

FIG. 13 is a perspective view of the filter module retention mechanism of FIG. 12 in isolation.

In the figures, like parts are denoted by like reference numerals. It will be appreciated that the drawings are for illustration purposes only and may not be drawn to scale.

FIG. 1 schematically illustrates an inkjet printer 101. The printer 101 comprises a printer main body 103 connected to printhead 105 by an umbilical cable 107. The printer main body 103 may comprise the ink supply system and a printer controller, and the printer main body 103 may have a display 109 (e.g. a touchscreen) for use by an operator. The printhead 105 is arranged to print on a substrate, such as the surface of an item 111, moving along a production line 113.

Referring now to FIG. 2, a simplified schematic diagram of a possible fluid system for the ink jet printer of FIG. 1 is shown. The ink jet printer 101 comprises an ink supply system 115 which is contained within the main printer body 103. The ink supply system 115 comprises an ink tank 117 for storing ink. A mixing head 123 is disposed below the fluid level of ink tank 117 and is connected to an ink pickup line 119. The ink pickup line is itself connected to a pump 121. Therefore, the fluid in the ink tank 117 is in fluid communication with the pump 121 with ink also passing through the mixing head 123. The pump 121 has an outlet connected to a 3:2 valve 122. The 3:2 valve is operable to connect the pump 121 with a filter 126 to allow ink to be supplied from the ink tank 117 to a printhead 105 (as described in more detail below). The 3:2 valve also allows the pump to be connected to a mixing pickup 120, which is provided within the ink tank 117. The pump 121 may be operated in a forward or reverse direction. When the pump 121 is operated in its forward direction, and the 3:2 valve 122 is configured to connect the pump outlet to the filter 126, the fluid system is referred to as being in a forward configuration. In the forward configuration, ink is drawn from the ink tank 117 via the mixing head 123 and the ink pickup line 119 by the pump 121 towards the 3:2 valve 122. The pump drives the ink through the 3:2 valve 122 and then the filter 126. The filter 126 has an outlet connected to a damper 125.

The damper 125 is provided after the filter 126 to reduce fluctuations in ink pressure within the ink supply. A pressure sensor 129 is provided at the damper outlet and is configured to monitor the pressure at the outlet of the damper 125. A valve 127 is provided downstream of the pressure sensor 129. An ink supply line 128 is configured to carry ink from the ink supply system 15, along the umbilical 7, to the print head 5. The ink supply line 128 is connected to the ink pickup line 119 via the pump 121, 3:2 valve 122, filter 126, damper 125 and valve 127. Thus in the forward configuration, ink is drawn from the ink tank 117 toward print head 105. The valve 127 is configured to control the ink supply to the print head 105.

The ink supply system 115 also includes an ink cartridge connection 131 which may be connected to an associated ink cartridge 133 and a solvent cartridge connection 135 which may be connected to an associated solvent cartridge 137. The ink cartridge 133 and ink cartridge connection 131 are connected to an ink refill line 141, allowing ink to be drawn through a valve 143 by a pump 145 (e.g. a diaphragm pump), and fed to the ink tank 117.

Similarly, the solvent cartridge 137 and the solvent cartridge connection 135 are connected to a solvent refill line 149, allowing solvent to be fed via a valve 151 to the ink tank 117 under the suction of the pump 145. Each of the valves 143, 151 can be operated independently allowing either ink or solvent to be supplied to the ink feed tank independently of one another under the control of the pump 145.

In some configurations, an ink reservoir and/or a solvent reservoir (not shown) may be provided to temporarily store ink or solvent between the cartridge 133, 137 and respective refill line 141, 149.

In order to function properly, the ink supplied to the print head 115 must be within specified viscosity limits. The ink tank 117 acts as a premixed ink reservoir, such that any ink drawn from it conforms to viscosity specifications. The precise mix of ink and solvent is maintained by controlled admission of ink and solvent from the ink cartridge 133 and the solvent cartridge 137.

As described above, in use, ink is fed along the ink pickup line 119 and ink supply line 128 to the print head 105 via the umbilical 107. Within the print head 105 the ink is provided to a droplet generator 155. The ink is provided to the droplet generator under pressure (under the influence of the pump 121) and is forced through a nozzle of the droplet generator 155 forming an ink jet 157. The ink jet 157 begins as a constant stream of ink and, under the influence of surface tension and vibrations applied in the droplet generator 155 (e.g. by a piezoelectric oscillator), gradually separates into a series of ink droplets 159 which continue to travel in the direction of the ink jet 157.

In some printers (such as that illustrated in FIG. 2) a purge line 158 is connected to the droplet generator. The purge line 158 may be connected to a purge port of the droplet generator 155. The droplet generator 155 may be provided as part of a droplet generator assembly, which includes a droplet generator body having known acoustic properties, and a piezoelectric oscillator. The purge port may be provided by the body, or by a separate part connected to the body. The purge line 158 allows ink to flow out of the droplet generator via a purge aperture without passing through the nozzle, and allows the droplet generator to be cleaned. The purge line 158 extends from the droplet generator 155, along the umbilical 107, and returns ink (or solvent), depending upon the phase of operation, to the ink feed tank 117. One or more valves (not shown) may be provided within the purge line 158. It will be understood that the purge line is not essential, and may be omitted in some printers. Further, additional fluid lines may be provided in order to support some printer operations. For example, a solvent supply line may be provided in order to allow clean solvent to be supplied to the printhead for cleaning purposes.

Shortly after emerging from the nozzle of the droplet generator 155, the ink jet 157 is passed through a charge electrode 161. The point at which the continuous ink jet 157 separates into droplets 159 is arranged to occur within the charge electrode 161. The ink is an electrically conductive liquid, and the droplet generator is conventionally held at a fixed (e.g. ground) potential. A variable voltage is applied to the charge electrode 161 causing charge to be induced on the continuous stream of ink extending from the ink droplet generator 155 towards the charge electrode 161. As the continuous stream of ink (i.e. ink jet 157) separates into droplets 159, any charge induced on the ink within the droplet becomes trapped at the moment the individual droplet breaks off from the main stream of ink 157. In this way, a variable charge can be applied to each of the ink droplets within the stream of ink droplets 159.

The stream of ink droplets 159 then continues to pass from the charge electrode 161 and through an electrostatic field. In the illustrated example, the stream of ink droplets 159 passes between deflection electrodes 163, 165. A first one of the deflection electrodes 163 is held at a first voltage, whereas the second one of the deflection electrodes 165 is held at second voltage, with a large potential difference (e.g. 8-10 kilovolts) established between the deflection electrodes 163, 165. In some systems, one electrode may be maintained at a ground potential while the other electrode is held at a high (positive or negative) voltage (with respect to ground). In other systems, one electrode is held at a negative voltage (with respect to ground) and the other electrode is held at a positive voltage (with respect to ground). In a further alternative, only a single deflection electrode, or a plurality of deflection electrodes, are provided. The field established by the deflection electrodes 163, 165 causes any charged droplets (i.e. those that have been charged by the charge electrode 161) to be deflected. In this way, based upon the variable charge applied by electrode 161, the droplets 159 can be selectively (and variably) steered from the path along which they are emitted from the nozzle of the droplet generator 155.

Droplets which pass through the deflection field without being deflected travel to a gutter 167. The gutter 167 comprises an orifice into which the droplets enter. The gutter 167 is connected to a gutter line 169 which extends from the gutter back to the ink supply system 115. A valve 171 is optionally provided within the gutter line 169 enabling the line to be opened and closed. Suction is applied to the gutter line 169 by a suction system so as to draw ink along the line from the gutter back towards the ink supply system 15.

The suction is provided in many inkjet printers by the suction system which comprises a Venturi 173 (which may also be referred to as a jet pump). The Venturi 173 is provided within the ink supply system 115 and is configured to receive a pressurised flow of ink from the ink pump 121 through a Venturi supply line 175, which is connected to a second outlet of the filter 126. The ink flowing through the Venturi 173 from the Venturi supply line 175 returns to the ink feed tank 117 via an ink return line 177 after it has passed through the Venturi 173.

The Venturi comprises a conduit with a converging then diverging cross section. The Venturi generates a localised region of high-speed, low-pressure flow by means of a constriction. The high-speed, low-pressure region is in communication with a suction port 178. In use, the gutter line 169 is connected, via the suction port 178 to the Venturi 173. In this way, the low pressure region created within the Venturi 173 is used to apply suction to the gutter line 169.

Any ink flowing into gutter 167 will be caused to flow along the gutter line 169, and will eventually be sucked into the Venturi 173 (via suction port 78) and will exit the Venturi and will pass along the return line 177 before returning to the ink feed tank 117.

By using a Venturi in this way (i.e. as a jet pump), a system can be designed in which the main system ink pump 121 can generate both positive pressures (e.g. to supply ink to the print head) and negative vacuum pressure (e.g. to provide gutter suction).

The ink tank 117 is vented by a vent 179, preventing excess pressure building up within the ink tank 117. It will be understood, however, that venting air via the vent 179 may cause solvent vapour to be vented to the external environment, which may be undesirable (e.g. since the solvent will need to be replaced, and may be damaging to the environment). In some embodiments, a capture system 180 may be connected to the vent 179 to capture solvent from the vented air. The capture system 180 may comprise a condenser. Captured solvent may be returned to another location within the ink supply system 115, such as, for example, the ink tank 117. The capture system 180 may be connected to the pump 145.

The filter 126 is described above as filtering ink for delivery to the printhead via ink supply line 128, and also for delivery to the Venturi 173 via Venturi supply line 175. It will be appreciated, however, that in alternative arrangements separate filters may be used. That is a first filter may be provided to fine filtering for the relatively small volume of ink supplied to the printhead, whereas a second filter may be provided to more coarsely filter the larger volume of ink supplied to the Venturi 173.

An ink filter module 300, which can perform the dual filtering functions of the filter 126 described above, will now be described in detail with reference to FIGS. 3 to 7.

FIG. 3 shows a schematic cross section view of the ink filter module 300. The ink filter module 300 comprises a filter housing 301 comprising a connection portion 302 and a body portion 303. The connection portion 302 comprises an inlet port 305, a first outlet port 307, and a second outlet port 309. The three ports are provided on an end portion 302a of the connection portion 302. The connection portion 302 further comprises a side wall 302b. The filter module further comprises a first filter element 311 and a second filter element 313. The side wall 302b at least partially surrounds the first filter element 311. The body portion 303 comprises an end portion 303a and a side wall 303b. The side wall 303b at least partially surrounds the first filter element 311.

The filter housing 301 comprises a wall 315 (comprising end portions 302 a, 303a and side walls 302b, 303b) defining an enclosed filter chamber 317. The filter chamber 317 is in fluid connection with each of the inlet and outlet ports 305, 307, 309.

The first filter element 311 is disposed centrally within the filter chamber 317. An outer cavity 319 is defined within the filter chamber 317, outside the first filter element 311. The first filter element 311 is shown in more detail in FIGS. 4A-4D. FIG. 4A shows a first filter media 321 in perspective view. The first filter media 321 is a pleated filter media. The first filter media 321 is cylindrical, having a central cavity 323, through which runs a central axis A-A. The first filter media 321 comprises a polypropylene filter.

FIG. 4B shows the first filter media 321 in perspective view, surrounded by a pleat protection filter 325. The pleat protection filter 325 may be formed from a material, such as stainless steel, that has a greater resistance to chemical ink attack than the material of the first filter media 321.

The pleat protection filter 325 surrounds an outer surface of the pleated filter media, and also has a cylindrical shape. The presence of the pleat protection filter 325 is optional, but where present may increase the longevity of the pleated filter media. In particular, the pleated filter media may degrade over time, and portions of the pleated filter material may become free from the bulk of the first filter media 321. The pleat protection filter 325 may prevent any free portions of the pleated filter media from mixing with ink in the filter chamber 317 and/or being carried away from the first filter element 311.

The first filter element 311 further comprises a central support 327 disposed in the central cavity 323 (shown partly inserted in FIG. 4B). The central support 327 comprises a course grid of polypropylene support elements, and is provided to prevent collapse of the first filter media 321.

As shown in FIGS. 4C and 4D, the first filter element 311 also comprises a first end closure 328 (omitted in FIG. 4C) and a second end closure 329. The first end closure 328 is provided at a first end 330 of the first filter element 311, and the second end closure 329 is provided at a second end 331, opposing the first end 330.

The first filter element 311 further comprises a first filter element outlet port 333 disposed centrally on the first end closure 328, and configured to allow flow of ink from the central cavity 323. The first end closure 328 further comprises an output screen 334 (visible in cross section in FIG. 3), configured to prevent pleat media debris from exiting the central cavity 323 via the port 333.

The housing connection portion 302 is shown separately in FIG. 5A, and has a circular cross section when viewed along the axis A-A (as shown also in FIG. 4A). FIG. 5B shows first filter element 311 inserted into the housing connection portion 302. The first filter element outlet port 333 (see FIG. 4D) is inserted into a first filter element connection 335 provided by the housing connection portion 302 (see FIG. 5A).

The fully assembled filter module 300 is shown in FIG. 5C, with the housing body portion 303 now shown as present.

The filter module 300 further comprises a presence detection feature, which in the illustrated embodiment comprises a magnet support 337 having an aperture 339 for receiving a magnet (not shown).

The filter module 300 further comprises a removal handle 341 (shown in FIG. 5C, although not shown in FIG. 3), provided at the second end 331. That is, the removal handle 341 is provided as part of the body portion 303, and is provided at the opposite end of the filter module to the inlet port 305 and outlet ports 307, 309. The removal handle 341 allows a user to grip the filter module 300 to apply a pulling force to allow easier removal of the filter from the printer. Although not shown in all figures, the removal handle 341 (where present) may further comprise one or more apertures. Preferably, the removal handle comprises two apertures. The apertures provide openings through which an operator can grip, and manipulate (e.g. pull) the filter module 300.

The filter further comprises an engagement structure 343 for engagement with a complementary structure of a printer to secure the filter in an installed configuration (described in more detail below). In the illustrated embodiment, the engagement structure 343 is incorporated into the handle 341. The engagement structure 343 allows for the filter to be securely engaged with the printer. Providing a secure engagement between the filter and a printer mitigates against unintentional release or ejection of the filter, for example when the filter is placed under pressure caused by ink pumping through the filter.

Also shown in FIG. 5A is an (optional) inlet filter 345 (mostly hidden), and the second filter element 313. The second filter element 313 comprises a second filter media 314, such as a stainless steel mesh filter media. The second filter element 313 is provided in the filter housing 301. In particular, the second filter element 313 is received in a portion of the filter housing that defines the second outlet port 309, as shown most clearly in FIG. 3.

The first filter media 321 has a first absolute rating. The second filter media 314 has a second absolute rating. The first absolute rating is different to the second absolute rating. The term “absolute rating” may also be referred to as a cut-off point of a filter, or as absolute micron rating. Such a rating defines the diameter of the largest particle that may pass through the filtration medium of a filter element. In use, less than 1% of particles larger than an absolute filter rating would be expected to pass through a filter. An alternative filter definition is a nominal rating, above which size around 5% of particles may pass, even in normal operation. A filter may thus be defined in terms of a nominal rating, or an absolute rating, In either case, the filter may be said to remove particles above a predetermined size from the filtrate.

The absolute rating of the second filter media 314 is greater than the absolute rating of the first filter element 321. The nominal rating of the second filter media 314 is greater than the nominal rating of the first filter element 321.

In an example, the absolute rating of the second filter media 314 is 200 μm. The second filter element 313 may take the form of a top-hat filter, a disk filter, or any convenient shape. The second filter media 314 may be formed from a solvent compatible material having a high tolerance to operating in solvent based ink, e.g. stainless steel.

The absolute rating of the first filter element 321 may be 40 μm, with a nominal rating of 10 um. The pleat protection filter 325 may have an absolute rating of 40 μm.

In practice, the filter ratings are selected to provide adequate protection for the orifices they protect. As such, the printhead and associated nozzle (which may have an orifice of the order of several tens of um, e.g. 30-75 μm) will generally be protected by a finer filter than protects the Venturi (which may have an orifice of the order of several hundreds of um or even greater, e.g. 300 μm to 1.5 mm).

The first filter media 311 and second filter media 314 each also have an effective surface area, which, along with the rating, determines the rate at which ink will pass through the respective filter, and also the rate at which filter performance will degrade over time. The term effective surface area refers to the total area of the filter media exposed to the flow of fluid that is usable for filtration. Such an effective surface area may be significantly larger than the geometric surface area of the filter media where a depth filter is used (e.g. a foam, multi-layer filter, or random fibre filter).

A filter having a smaller effective surface area will degrade more quickly than a filter having larger effective surface area (for the same rating). The effective surface area of each filter media will thus be selected so as to meet a convenient expected maintenance interval. For example, the second filter media 314 may be selected so as to have a large enough surface area that substantially all dust that has been sucked into the system via the gutter 67, all ink coagulation with such dust, water, oils and food and drink vapours from a factory environment, and debris resulting from the pleat filter and housing itself, can all be captured by the second filter element 313 without the pressure drop through the second filter element 313 being excessive, even after a year of operation.

The effective surface area of each filter will also be selected so as to provide a sufficient fluid traversal speed. That is, an excessively large filter may cause extremely slow fluid flow velocity, and associated increased sedimentation. Further, since it is preferable for the filter module 300 to be emptied (e.g. into the ink tank 17) during a shutdown, the total fluid volume of the filter module 300 should be minimised. It will be appreciated, therefore, that the optimum size for the each filter depends on the particular performance and maintenance requirements for the printer 1.

The effective surface area of the first filter media 321 is significantly greater than the effective surface area of the second filter media 314.

During normal use, the flow rate of ink through the second filter element 314 is greater (e.g. at least twice as much) than the flow rate of ink through first filter element 311. For example, during normal use, the rate of flow of ink to the printhead 5 may be around 4-6 ml/minute. On the other hand, the rate of flow of ink through the Venturi 73 may be around 100 times more than the rate of flow of ink to the printhead 5.

The first filter element 311 has a cylindrical shape. Such a shape conveniently provides a large surface area over which ink can pass. Advantageously, the total flow rate of ink through the filter module 300 can be kept above a predetermined minimum rate, thereby reducing the likelihood of sediment settling in the first filter element 311, while also allowing for a desired flow rate of ink to pass from the inlet port 305 to the first outlet port 307.

The second filter element 313 also has a cylindrical shape. The second filter media 314 comprises a mesh filter, such as, for example a stainless steel mesh filter.

The nominal rating of the first filter element 321 is defined by the pleated filter media. The absolute rating of the first filter element 321 is defined by the output screen 334. Thus, the performance of the first filter element is be principally determined by the pleated filter media, rather than the pleat protection filter 325, the supporting structure 327, or the output screen 334. That is, the lowest nominal rating is provided by the first filter media 311, which is operable to impede a majority of the particles that are impeded by the filter element 321.

In an alternative arrangement, the first filter media 321 may comprise a stainless steel mesh filter media. For example, the first filter medium may be a stainless steel depth filter. Advantageously, the number of components of the first filter element would be minimised. Alternatively, the first filter media may comprise a polypropylene mesh or a PTFE mesh.

The output screen 334 may be a stainless steel mesh, and may allow continued printer operation without significant component damage for a short period of time even after considerable degradation to the pleated first filter media 321. Alternatively, the output screen 334 may be formed from a solvent compatible material having a high tolerance to operating in solvent based ink. The output screen 334 may have a similar absolute rating to the first filter media 321.

As can be seen in FIG. 3, when the filter module 300 is fully assembled, the first filter element 311 is provided within the filter chamber 317. The first end closure 328 abuts an internal wall of the filter housing 301, securing the location of the first filter element 311 within the housing 301. The second end closure 329 may be spaced apart from the internal wall of the filter housing 301. The first filter element 311 defines a generally cylindrical side wall which extends between the first and the second ends 330, 331.

The filter module 300 is shown in FIG. 3 in an “in use” orientation. That is, when the filter module 300 is installed in a printer 100, it is oriented with the axis A-A aligned horizontally, with the positive z-direction representing a direction that opposes gravity. The inlet port 305 is provided at the bottom, the first outlet 307 at the centre, and the second outlet put 309 at the top. In use, ink is pumped by the ink pump 21 into the inlet port 305, and out of the first outlet port 307 (to supply the printhead 5), and out of the second outlet port 309 (to supply the Venturi 73).

The filter module is particularly well suited for filtering pigmented ink, such as hard pigmented ink in a continuous inkjet printer of the sort described with reference to FIGS. 1 and 2. By arranging the filter module 300 in such a way that ink can pass through the first filter element 311 with a different absolute rating (or effective pore size) to the second filter element 313, there is no need to filter all ink in the filter ink to a purity that is required for use in a printhead 5. Instead, only the (relatively small) flow rate of ink that needs to be supplied to a print head is filtered to a desired filtration level. The remaining ink can pass through the second filter element 313, having a different absolute rating (or effective pore size), so as to be more coarsely filtered. Such a filter (i.e. the second filter element 313) can prevent larger debris or particles from reaching the Venturi 73. However, it has been realised that filtering all ink at a high absolute rating can lead to excessive filter performance degradation, resulting in shorter service intervals (in order to replace blocked ink filters).

Further, providing the first filter element 311 and the second filter element 313 in a single filter housing (i.e. housing 301), allows for simple replacement of the filter module 300, reducing downtime of a printing system, and minimising waste. It will be understood that the first filter element 311 and the second filter element 313 may be designed in such a way that they are expected to require replacement at a similar time, so as to minimise unused filter capacity.

FIG. 6 shows a simplified cross section view of the filter module 300. A first filtrate path 350 is defined from the inlet port 305 to the first outlet port 307 via the first filter media 321. The first filtrate path 350 is shown passing through the first filter media 321 at filtration location 351. The first filtrate path 350 then emerges into the central cavity 323, before exiting via first filter element outlet port 333, first filter element connection 335 (provided by the housing connection portion 302), and first outlet port 307. Filtrate 350F exiting the first outlet port 307 thus comprises a portion of the fluid flowing into the inlet port 305 that is filtered by the first filter media 321. No paths exist from the inlet port 305 to the first outlet port 307 that do not pass through the first filter media 321. The first filtrate path may be referred to as “through-flow” path (with reference to the first filter media 321). That is, the filtrate 350F has flowed through, and thus been filtered by, the first filter media 321.

A second filtrate path 352 from the inlet port 305 over an outer surface of the first filter element 311 in the outer cavity 319, and then to the second outlet port 309 via the second filter media 314. The second filtrate path 352 is shown passing through the second filter media 314 at filtration location 353 before exiting via the second outlet port 309. Filtrate 352F exiting the second outlet port 309 thus comprises a portion of the fluid flowing into the inlet port 305 that is filtered by the second filter media 314. The second filtrate path 352 effectively bypasses the first filter element 311. While the second filtrate path 352 is shown passing around the second end 331 of the first filter element 311, it will be appreciated that several paths exist that make-up the second filtrate path 352. Some of these paths pass around the circumference of the first filter element 311. For example, the second filtrate path 352 comprises a path defined between an outer surface of the first filter element 311, and a wall of the main chamber, defined by the filter housing 301. Other paths of the second filtrate path 352 may pass around the first end closure 328 (bypassing the first filter outlet 333). Thus, the second filtrate path effectively surrounds an outermost or external surface of the first filter element 311. It will be appreciated, however, that it is not necessary for the second filtrate path to completely surround all surfaces of the first filter element. That is to say, ink flowing to the second outlet port 309 passes across part of an outermost surface of the first filter element (e.g. a side wall of the filter element), or pleat protection filter 325.

The second filtrate path may be referred to as a “cross-flow” path (again, with reference to the first filter media 321). That is, the filtrate 352F has flowed across a surface of the first filter element 311, but has not been filtered by the first filter media 321.

A third filtrate path 354 is defined from the inlet port 305 to the second outlet 309, via the first filter media 321, and then the second filter media 314. The third filtrate path 354 is shown passing through the first filter media 321 at filtration location 355. The third filtrate path 354 then emerges into the central cavity 323, before exiting via the filter media 321 (for a second time) at filtration location 356 to the outer cavity 319 surrounding the first filter element 311. The third filtrate path then passes between the housing 301 and the filter element 311, before passing through the second filter media 314 at filtration location 357, before exiting via the second outlet port 309. Filtrate 354F exiting the second outlet port 309 thus comprises a portion of the fluid flowing into the inlet port 305 that is filtered by the second filter media 314, as well as the first filter media 321 (twice). The third filtrate path may be referred to as a “counter-flow” path (again, with reference to the first filter media 321). That is, the filtrate has flowed through the first filter media 321 first and second times, the second time being in a direction which is opposite to the main bulk flow direction. The passage of filtrate through the first filter element for a second time to the outer region surrounding the first filter element causes the first filter element to be “back-washed”. The flow of filtrate in a direction which is opposite to the first filtrate path reduces the extent to which filtered particles are retained by the first filter media.

The provision of the cross-flow and counter-flow filtrate paths allows a higher overall flow rate of ink to pass through the filter module than would occur if only the flow that is traversing to the print head was flowing through a filter. This is particularly advantageous as the likelihood of any sediment in the ink settling in the first filter element is reduced, due to a higher overall flow rate. The filter housing 301 is sized and configured in dependence upon printer requirements to alter the desired cross flow rate, through flow rate, and counter flow rate.

The second filtrate path 352 (cross-flow) represents the majority of the total flow of ink within the filter, in view of the relatively limited flow restriction in the path, as compared to the first filtrate path 350, which must pass through the first filter element 311. It will be understood, of course, that the amount of flow through filter module 300, and the relative distribution of flow between the first, second and third filtrate paths can be varied by changing the size of the gaps between the first filter element 311 and the filter housing walls 315, and by varying the properties of the first filter element 311 itself. In some circumstances, flow along the third filtrate path may be minimal, or even negligible. However, at other times (e.g. during re-filling the filter chamber 317 with ink) flow of air and/or ink along the third filtrate path may be more significant. It will also be appreciated that a clear distinction between the different filtrate paths may not be possible in all instances. The flow of fluid (ink and air) within the filter module 300 will be complex, and at times turbulent.

It should also be noted that the flow of fluid through the pleated first filter media 321 (whether as part of the first or third filtrate paths 350, 354) may often comprise an element of the fluid flowing across a surface of the first filter media 321 before a path through the pleated filter media is found.

The first, second and third filtrate paths 350, 352, 354 are paths along which ink can flow within the filter module 300 during normal operation of the printer.

As shown in FIG. 3, when the filter module 300 is configured for use the first outlet port 307 and the second outlet port 309 are arranged vertically above the inlet port 305. It can be seen that the first outlet port 307 and the second outlet port 309 are spaced apart, in a vertical direction (i.e. the z-direction), from the inlet port 305. The outlet ports 307, 309, are thus provided at a higher position on the filter housing 301, when it is installed for use. Thus, during in normal use, each of the first, second and third filtrate paths comprises a vertically upwards component from the inlet to the first and second outlet ports. The filter module 300 is thus arranged to cause ink to flow in a generally upwards direction from the inlet port 305 to the first and second outlet ports 307, 309. The flow of the ink via each of the first, second and first filtrate paths may therefore be in a generally upwards direction. Advantageously, this reduces the likelihood of sediment settling in the filter.

Flowing in an upwards direction, or a generally upwards direction, encompasses ink flowing in a direction that comprises a vertical component. In other words, the flow direction of ink comprises a component that is in a direction that is opposite to gravity. The overall flow of the ink through the filter chamber 317 may therefore be in a generally upwards direction. Advantageously, this reduces the likelihood of sediment settling within the filter module 300. Causing ink to flow in an upwards direction is also advantageous following shutdown, and emptying of the filter during shutdown. Emptying the filter during a shutdown reduces settling of sediment and pigment. Nevertheless, some resin may deposit on the surfaces of the pleat material of the first filter element 311, which may block the filter. When ink is resupplied to the filter after a shutdown, the settled resin is washed back into suspension in the ink, and does not block the first filter element 311. Allowing emptying of the filter in this way may increase the longevity of the first filter element 311 and the second filter element 313.

It can further be seen from FIG. 3 that the first outlet port 307 and the second outlet port 309 are vertically separated from one another. In particular, the second outlet port 309 is arranged vertically above the first outlet port 307. While this arrangement is not essential (the outlet ports could be at a similar vertical location, or reversed), providing an outlet (e.g. second outlet 309) at the top of the housing 301 allows air to be introduced into the filter chamber 317 when the filter module 300 is drained (e.g. for periods of expected inactivity), and vented from the filter chamber 317 when the filter module is re-filled after being drained.

Put another way, the inlet port 305, the first outlet port 307, and the second outlet port 309 may each define a centroid, the vertical distance between the centroid of the inlet port 305 and the centroid of the second outlet port 309 may be greater than the vertical distance between the centroid of the inlet port 305 and the centroid of the first outlet port 307. As such, in use, more work must be done against the force of gravity to pump ink to the second outlet port 309 compared to pumping ink to the first outlet port 307.

The second outlet port 309 may be directly vertically above in the first outlet port 307 (as illustrated). However, in some variants, the second outlet port 309 may be provided in a region of the filter housing that is spaced vertically above the first outlet port 307 but not necessarily lying in the same plane, or directly above the first outlet port 307 in the z-direction. An offset in either of the x-or y-directions may be applied.

Providing the second outlet port 309 vertically above the first outlet port 307, in use, is advantageous because any air in the chamber 317 can exit the filter housing 301 via the second outlet port 309, instead of through the first outlet port 307 which may be connected to a printhead 5. As such, air bubbles which may become trapped in the filter housing 301 can be readily removed without passing to a print nozzle. The second outlet port 309 may be provided at the top of the chamber 317, thereby allowing air remaining in the filter to be vented. Of course, this benefit may be achieved without the second outlet port 309 being precisely at the top of the chamber 317.

As described above, the flow of ink along the first filtrate path 350 is in a direction generally opposite to the direction that gravity acts. Similarly, flow of ink along the second filtrate path 352 is in a direction generally opposite to the direction that gravity acts. Further, flow of ink along the third filtrate path 354 is in a direction generally opposite to the direction that gravity acts.

In the event of an unexpected loss of power, any pigment will settle towards the bottom surface of the chamber 317 (i.e. in the negative z-direction, as shown in FIG. 3). By providing the inlet port 305 close to the bottom of the filter module 300, pressurised ink entering the filter upon system start-up will agitate any settled ink pigment, and cause the pigment to re-mix. It will be understood, however, that the port inlet 305 is not required to be immediately at the bottom of the chamber 317 in order to achieve this benefit.

During a planned shutdown of printing, the contents of the filter chamber 317 may be drained into the ink tank, so as to reduce the risk of sedimentation within the filter module 300. During such a shutdown, the filter may be maintained in a saturated vapour environment, minimising the drying of ink, and reducing difficulties associated with re-wetting. This may be achieved by maintaining a fluid connection between a solvent-saturated atmosphere in the ink tank 117, and the internal volume of the filter chamber 317. Such treatment of the filter may allow shut-down events of around one-month or more.

Upon start-up after a period of shutdown, the pump 21 may be arranged to cause a higher ink flow rate through the filter module 300. This promotes re-mixing of any sediment or resin that may have settled in the filter module 300, in particular in or on the first filter element 311 and/or the second filter element 313, and thus reduces the likelihood of blockages of the first and second filter elements 311, 313.

During a start-up process, when the filter chamber 317 is re-filled with ink, the first second and third filtrate paths described above 350, 352, 354, along with the geometry of the filter module inputs and outlet ports 305, 307, 309, will allow substantially all of the air to be vented from the chamber 317 in an efficient manner. In particular, as ink is re-introduced at the inlet 305, the level of ink within the chamber will begin to rise around the first filter element 311. A portion of the ink will pass through the first filter element into the central cavity 323, before leaving the cavity 323 via the first outlet port 307, along the first filtrate path 350. A larger portion of the ink will pass around the first filter element 311, via the outer cavity 319, before leaving the cavity via the second outlet port 309 (and second filter element 313, along the second filtrate path 352.

Air within the chamber 317 will primarily be driven out the second outlet port 309. It will be appreciated, however, that the rising level of ink will displace air from within the central cavity 323 at a rate that is generally greater than can be accommodated by the first outlet port 307 (which typically allows a flow of around 4-6 ml of ink per minute to the printhead). As such, air within the central cavity 323 will be displaced through the upper part of the first filter element, into the outer cavity 319. This flow of air, and then ink, will follow the above-described third filtrate path 354. This process of air and ink (including a period of mixed flow) flowing through the first filter element 311 (e.g. at filtration location 356) will perform a washing effect on the first filter media 321. In some embodiments, the first outlet port 307 may be selectively closed through use of one or more valves. In this way, by closing the first outlet port 307 such that air and/or ink cannot leave the central cavity 323 by the first outlet port 307, displacement of air from the central cavity 323 via the printhead can be avoided, with substantially all air displaced instead to the outer cavity 319 and then via the second outlet port 309.

Eventually, after an extended period of use, it will be necessary (or at least advisable) to replace the filter module 300 in a printer 1. By arranging the inlet port 305, the first outlet port 307, and the second outlet port 309 on a single face of the filter housing 301 (i.e. at the first end 330), it is possible to install and remove the filter module in a simple operation.

The filter module 300 can be removed by pulling on the removal handle 341 (not shown in FIG. 3) in an axial direction, in the positive x-direction. The removal handle allows a user to grip the filter to apply a pulling force to allow easier removal of the filter from the printer.

A replacement filter module can be installed by aligning the ports 305, 307, 309 with corresponding female ports provided by the printer and pushing the filter into place. A mechanical guide feature (not shown) may be provided to ensure correct orientation and alignment.

The printer 1 may be configured to detect that a new filter module has been installed. For example, the filter module 300 may comprise a presence detection feature configured to interact with a detector provided by the printer. In the illustrated embodiment, the presence detection feature comprises a magnet that is inserted in aperture 339, and supported by magnet support 337. The printer 1 comprises a Hall effect sensor arranged to detect the magnet. Other suitable presence detection mechanisms and motion sensors may be provided. The presence detection mechanism may be used to control operation of the pump 21 and hence the flow of ink into the inlet port 305.

The magnet support 337 may also serve as an alignment feature (although an alternative feature, such as a protruding member or a rib, which extends from a side of the filter housing, could be provided). This is advantageous as it ensures correct orientation of the filter module when being provided in a printer. In some arrangements, the filter module may be symmetrical. However, where this is not true (e.g. where inlet filter 345 is not provided) it may be important that, in use, the second outlet port 309 is the uppermost port, and the inlet port 305 is the lowermost port.

The filter further comprises an engagement structure for engagement with a complementary structure of a printer to secure the filter in an installed configuration. Providing a secure engagement between the filter and a printer mitigates against unintentional release or ejection of the filter, for example when the filter is placed under pressure caused by ink pumping through the filter.

The filter module 300 has been described above in the context of a particular type of continuous ink jet printer 1. However, it will be appreciated that alternative ink circuits or printer types may be used. Thus, the filter module 300 may be used, in general, in combination with a continuous inkjet printer comprising an ink circuit, the ink circuit comprising an ink tank (e.g. tank 17), an ink pump arrangement (e.g. pump 21).

As described above, the printer 1 comprises a pressure sensor 29. The pressure sensor is configured to sense the pressure within the ink supply line 28 downstream of the filter module 300 (i.e. downstream of first outlet port 307).

In some embodiments, a pressure sensor may be provided to measure a drop of pressure between the inlet port 305 and the first outlet port 307. Alternatively, or in addition, a pressure sensor may be provided to measure a drop of pressure between the inlet port 305 and the second outlet port 309. In this way, the pressure drop across the first filter element 311 and/or the second filter element 313 can be measured. In some embodiments, a single pressure sensor may be configured to sense pressure in multiple locations, for example, by being connected to the first outlet port 307 and the second outlet port 309 via a switchable valve arrangement (not shown).

Sensing the pressure drop across the first filter element and/or the second filter element may be used to determine when the first and/or second filter elements 311, 313 need replacing. A measured change in pressure across the first filter element and/or second filter element may be compared against known or tested drops in pressure to determine when the first filter element and/or second filter element needs replacing or cleaning. The pressure drop may be measured during start-up of the printer or during shutdown of the printer. When the pressure drop reaches a predetermined value, this may be indicative that the first filter element and/or the second filter element requires replacement. The pressure sensor may be coupled to a printer controller. Such a printer controller may be configured to control the printer based on the pressure readings (e.g. to adjust the ink pump rate in dependence upon the pressure readings) in order to maintain a desired pressure in the ink supply line 28, and to maintain a desired flow rate through the Venturi 73, in spite of filter degradation.

In some examples a pressure sensor is provided to sense pressure at each of the two filter outlet ports 307, 309. Such an arrangement is particularly beneficial where the filter has two outlet ports 307, 309, since a blockage of the first filter element 311 may not be detected by a pressure sensor that only monitors the pressure downstream of the second filter element 313, and vice versa. If only a single pressure sensing location was provided (e.g. in the ink supply line 28), then it is possible that a printer would fail to compensate for a loss in Venturi flow rate, leading to a reduction in gutter suction, and eventual ink return failure.

The pressure sensor readings may be performed during printing, or when printing is not being performed. Indeed, filter degradation is a process that typically occurs over an extended period of time. As such, pressure sensing may be performed during a start-up or shut-down sequence. Such operation may allow the convenient use of a single pressure transducer to be connected sequentially to different pressure sensing locations (e.g. input port 305, output port 307, and output port 309), with the printer controller then taking suitable action (e.g. to modify a pump control signal in view of the pressure readings, and/or to generate a warning).

The filter module 300 has been described above in an assembled form. However, it will be appreciated that parts of the filter module 300 may also be provided separately. For example, the first and second filter housing components (i.e. the connection portion 302 and the body portion 303) may be provided separately. During a manufacturing process the filter module 300 may be constructed according to the following steps, as illustrated by FIG. 7.

In a first step S1, pleat media is obtained and cut to the required size. At a second step S2, the cut pleat media is formed into the cylindrical form of the first filter media 321 shown in FIG. 4A, by welding (e.g. sonic welding) a seam between ends of the cut pleat media. In a third step S3, the welded pleat media (i.e. first filter media 321) is assembled with the central support 327, and pleat protection filter 325. At a step S4, the output screen 334 is welded to the first end closure 328.

At step S5 the assembled first end closure 328 and the second end closure 329 are welded to either ends of the first filter media 321 with central support 327 and pleat protection filter 325. An O-ring 333a is provided around the first filter element outlet port 333. The first and second end closures 328, 329 are both welded (e.g. by thermal welding). The assembled component is as shown in FIG. 4D (shown without O-ring 333a). It will be appreciated that steps S1, S2 and S3 can be performed in parallel with step S4, but necessarily before step S5.

At a subsequent step S6 the housing protection portion 302 is provided. At step S7 Filters are inserted into each of the inlet port 305, and the second outlet port 309. The second filter element 313 is provided as the filter at the second outlet port. An identical inlet filter may be provided in the inlet port 305, although maybe omitted (as shown in FIG. 3).

At a subsequent step S8, the assembled first filter element 321 (from step S5) is inserted into the housing connection portion 302 (from step S7) with the first filter element outlet port 333 being engaged with the appropriately provided first filter element connection 335, provided by the housing connection portion 302.

At a subsequent step S9 the housing body portion 303 is provided and joined to the assembled housing connection portion 302. The join between the two housing components 302, 303 may be made by spin welding. The use of spin welding is advantageous, since it does not required other materials, provides a good seal, and does not rely upon chemical adhesives.

At a subsequent step S10, O-rings 305a, 307a, and 309a may be provided in grooves on each of the inlet port 305, first outlet port 307, and second outlet port 309. At a subsequent step (not shown), a magnet maybe inserted in to the magnet aperture 339. Prior to assembly, the various components have been separately manufactured. For example, the housing portions 302, 303 maybe formed by injection molding.

Various joining methods are described above, including heat welding, sonic welding and spin welding. Adhesives may be used to join some components, but are generally not preferred, in order to minimise the risk of chemical incompatibility between the adhesive, and the solvents used within the printer.

It is noted, however, that some welding processes may result in swarf and other plastic particles that are generated during processing becoming trapped within the filter housing 301. The filter housing 301 may typically be made from polypropylene, which may itself begin to degrade after extended periods of use, producing further debris. These depositions (whether generated during manufacture, or use) are preferably captured by the filter (e.g. the second filter element 313) so as to minimise the risk that they will cause a blockage elsewhere in the printer.

It will of course be appreciated that the above described manufacturing and assembly method is provided as an example only. Alternative manufacturing and assembly methods maybe used. Furthermore, where separate parts as described herein that are subsequently joined together they may be referred to as a single part. On the other hand, where composite parts are described herein, they may be provided by separate parts that are joined together by any convenient method.

In the example described above, o-rings are used to seal various ports. However, in some alternative examples the use of an interference fit may be preferred, so as to minimise deformation or warping of the plastic of the filter housing and end closures.

In a further alternative example, the filter housing may be formed from stainless steel. In some embodiments, the filter sizes may be increased so as to provide an expected filter service life equivalent to that of the printer. Of course, such a filter may still require replacement where the filter becomes blocked or contaminated, e.g. due to extreme operating conditions.

In an alternative arrangement shown in FIG. 8, an alternative filter module 300′ is provided. The alternative filter module 300′ is similar in structure to the above described filter module 300. However, rather than having external O-rings 305a, 307a, and 309a, each of the inlet and outlet ports are provided with orifices 305′, 307′ and 309′, having internal O-rings 305a′, 307a′, and 309a′. The printer for use with such an arrangement comprises suitably arranged protrusions 305b′, 307b′, and 309b′ for engagement with the orifices 305′, 307′, and 309′. In such an arrangement, O-rings may be provided around the protrusions. At each filter replacement interval, the O-rings are replaced.

Such an arrangement maybe preferred since it allows for more complete cleaning of the arrangement at each service interval. That is, any debris trapped within the orifices of the filter module 300′ will be removed when the filter module 300′ is replaced.

It is further noted that the first filter element 311 engages with the housing via the outlet 333 and corresponding connection 335. An O-ring 333a is provided at the junction. In an alternative embodiment the O-ring may be omitted and the filter assembled by interference fit, or welding.

The filter module 300 maybe provided with a data storage device (e.g. an RFID tag) configured to contain information regarding the filter construction, date of manufacture, lot number, etc. The printer may interrogate such a data storage device in order to ensure compatibility between the filter module and the printer in which it is to be installed. Alternatively, such a data storage device maybe provided in order to allow tracking of components.

In the above-described examples the second filter element 313 is described as being provided within the filter module 300. In particular, the second filter element 313 is described as being provided within the second outlet port 309. It will be understood, however, that alternative arrangements are possible. For example, the second filter element 313 could be omitted entirely. Alternatively, the second filter element 313 could be provided in an alternative location, such as outside the filter module 300, between the second outlet port and the Venturi 73. In some alternative arrangements, the Venturi pump may be omitted entirely, with gutter suction being provided by an additional pump. In such an arrangement, the second outlet port 309 may discharge directly to the ink tank 317, with or without further filtering.

Further, the filter system described above relates to a user replacable filter module. It will be understood, however, that in some examples the filter may be integrated with one or more further components of a printer. For example, the filter could be incorporated with a damper. Further still, a filter having the general geometric arrangement described above could be incorporated into an ink tank.

FIG. 9 is a perspective view of an assembly 400 for a continuous inkjet printer. The assembly 400 comprises a filter retention mechanism 402, which will be described in detail below, and a filter module 300.

The filter retention mechanism 404, as suggested, is configured to retain a filter module 300. Specifically, the filter retention mechanism 402 is configured to removably retain the filter module 300 such that the filter module 300 is secured in place in use but can be removed periodically for servicing and other maintenance.

The filter retention mechanism 402 comprises a first support 406 and a second support 408. The second support 408 is pivotally connected to the first support 406. Described another way, the second support is rotatable relative to the first support 406. The second support 408 is rotatable about an axis of rotation 410. The second support 408 is therefore rotatable in a direction indicated by arrow 412 (e.g. around the z axis) relative to the first support 406 (although, as shown in FIG. 9, the second support 408 is shown at one end of the rotational travel and so cannot rotate any further in a generally clockwise direction). The second support may otherwise be described as a rotatable, or removable, support.

In the illustrated embodiment, the first support 406 is a fixed support. That is to say, when the filter module 300 is removed from, or inserted into, the mechanism 402, the first support 406 does not rotate. This first support 406 may therefore otherwise be described a fixed support. The filter retention mechanism 402 may be mounted within the overall printer via the first support 406.

In the illustrated embodiment, the first support 406 comprises first and second retention features 414, 416. However, in other embodiments one or more of the first and second retention features 414, 416 may otherwise form part of the second support 408. In the illustrated embodiment the first retention feature 414 comprises a ledge of the first support 406. From herein the ledge will denoted by numeral 414.

As indicated in FIG. 9, when the filter retention mechanism 402 is in a locked configuration, upper (e.g. outer) surface 418 (e.g. a lid) of the filter module 300 is at least partly covered by (e.g. aligned with) the ledge 414 of the first support 406. Specifically, the upper surface 418 of the filter module 300 is overlapped by an underside of the ledge 414. The ledge 414 effectively acts to delimit the travel of the filter module 300, and prevents the filter module 300 from moving in the x direction past the point where the upper surface 418 contacts the ledge 414, relative to the first support 406, in a direction labelled 420 in FIG. 9. In use, the filter module 300 is urged in the direction 420 (e.g. in the x direction) by virtue of the pressure of fluids pumped through (e.g. into, and subsequently out of) the filter module 300. If not retained in position, the filter module 300 would likely be ejected from the mechanism by virtue of the pressure of fluids pumped therethrough.

A challenge with retaining the filter module 300 is that the upper surface 418 is generally domed (i.e. at least partly arcuate). A single restraint (e.g. only the ledge 414 in isolation) may lead to the upper surface 418 effectively forcing the filter module 300 out of the mechanism 402 by virtue of the interaction of the upper surface 418 and the ledge 414. Described another way, the filter module 300 may urge itself out of engagement with the mechanism 402 as the force 420 effectively wedges the second support 408 away from the first support 406. The present invention overcomes this issue as detailed below.

Continuing to describe the first support 406, in the illustrated embodiment the first support 406 further comprises a second retention feature 416, which may otherwise be described as a rotational latch. The second retention feature 416 takes the form of a clip in the illustrated embodiment. The clip will therefore be denoted by the numeral 416 moving forward. The clip 416 is configured to latch the mechanism 402 in the locked configuration shown in FIG. 9. The clip 416 thereby substantially prevents rotation of the second support 408 relative to the first support 406 when engaged. Although in the illustrated embodiment the clip 416 engages a projection 422 (e.g. a handle) of the filter module 300, it will be appreciated that in other embodiments the clip 416 could otherwise engage the second support 408. Similarly, although the second retention feature takes the form of the clip 416 in the illustrated embodiment, in other embodiments other rotational latch mechanisms could otherwise be used (e.g. a pivoting arm).

The clip 416 comprises a tapered engagement surface 424. Described another way, the tapered engagement surface 424 is generally wedge-shaped (e.g. triangular). As shown in FIG. 9, the thickness of the clip 416 is comparatively narrower at a first end 426, the first end 426 being the first end to engage the projection 422 of the filter module 300 in use, than a second end 428 of the tapered engagement surface 424. It will be appreciated that as the filter module 300 is urged into engagement with the first support 406, the projection 422 of the filter module 300 first contacts the first end 426 of the clip 416. As the thickness of the clip 416 increases moving towards the second end 428 (e.g. in the y direction), the clip 416 is elastically deformed (e.g. urged, in the x direction) by the continued travel of the projection 422 of the filter module 300. At the point where the projection 422 contacts the second end 428 of the clip 416, the clip 416 is at its greatest elastic deformation. Once the projection 422 moves past the second end 428, the projection 422 is received in a recess 430 the clip 416. At the point where the projection 422 moves past the second end 428 of the clip 416, the clip 416 returns to an at rest configuration (e.g. substantially no elastic defamation) to receive the projection 422 in the recess 430. Described another way, the clip 416 springs back (e.g. in the negative x direction). From FIG. 9 it will be appreciated that unless the clip 416 is deformed again, to allow the second end 428 to be clear of the (e.g. lifted past) projection 422, the projection 422, and so the filter module 300, will remain retained by the clip 416. For completeness, the clip 416 also comprises a cut-out 434 along part of its extent. By virtue of the presence of the cut-out 434, the clip 416 is easier to deform and it is therefore easier to urge the projection 422 of the filter module 300 past the tapered engagement surface 424 into the recess 430. Although the clip 416 is used as the second retention feature in the illustrated embodiment, it will be appreciated that other retention features could otherwise be used to achieve a similar rotational latching. For example, a hinged latch could otherwise be employed.

Turning to describe the second support 408, as previously described the second support 408 is pivotally connected to the first support 406. The second support 408 can therefore rotate, in direction 412, about axis of rotation 416 (and so about the z axis) relative to the first support 406. In the illustrated embodiment the rotation is provided by way of a pair of shafts 434 (only one being visible in FIG. 9) which form part of the second support 408. The pair of shafts 434 penetrate corresponding bores 436 (again, only one of which is visible in FIG. 9) which form part of the first support 406.

The second support 408 also comprises a base 438 and a support member 440. A collar 441 is coupled to the support member 440. The collar 441 is configured to receive the filter module 300. The collar 441 thus guides the filter module 300 into position about the second support 408. The collar 441 is annular in the illustrated embodiment, and may be described as a guide ring. The collar 441 extends entirely around a circumference of the filter module 300 in the illustrated embodiment.

The base 438 comprises a plurality of ports in the illustrated embodiment, which take the form of three female connectors: a first female connector 442, a second female connector 444, and a third female connector 446. Each of the first to third female connectors 442, 444, 446 are associated with a corresponding one port extending from the filter module 300. In the illustrated embodiment, the filter module 300 comprises three ports, an inlet port and two outlet ports. These are all provided at an end which opposes the upper surface 418. In other embodiments there may be more, or fewer, ports. Similarly, in other embodiments one or more male connectors may replace the female connectors 442, 444, 446 on the base 438. For completeness, only a first port 448 of the filter module 300 is labelled in FIG. 9, second and third ports are not visible in FIG. 9.

Each of the three ports 448 of the filter module 300 take the form of male connectors in the illustrated embodiment. As suggested by the name, the female connectors receive the male connectors when the filter module 300 is inserted (e.g. in the negative x direction). In other embodiments, one or more corresponding female connectors may replace male connectors 448 provided on the filter module 300. That is to say, the arrangement of male/female connectors shown in FIG. 9 may be reversed in other embodiments (e.g. such that the filter module 300 comprise female connectors, and the second support 408 comprise male connectors).

Optionally, each of the three female connectors 442, 444, 446 of the second support 408 have axial extents which are different. Described another way, each of the female connectors 442, 444, 446 may have different axial lengths. This has been found to be advantageous when removing the filter module 300 because the filter module 300 more gradually disengages from the second support 408 in comparison to arrangements where all of the female connectors 442, 444, 446 are the same length and the filter module 300 therefore disconnects from all of the female connectors at the same time. As mentioned above, this arrangement could equally be incorporate as part of the filter module 300 rather than the second support 408.

A method of inserting and retaining the filter module 300 will now briefly be described. Firstly, the filter module 300 is initially received by the second support 408 only. The second support 408 is urged away from the first support 406 so that an open volume (e.g. a filter-receiving volume) is defined into which the filter module 300 can be received. The filter module 300 is then received by the second support 408 such that ports 448 of the filter module 300 are received by corresponding female connectors 442, 444, 446 of the second support 408. Furthermore, the support member 440 also guides the filter module 300 into the correct position by virtue of abutment with the filter module 300. The combination of the filter module 300 and the second support 408 are then urged towards the first support 406 by virtue of rotation about the axis of rotation 410 (e.g. about direction 412, and about the z axis). As the second support 408 and filter module 300 are urged towards the first support 406, the upper surface 418 of the filter module 300 is gradually overlapped (e.g. capped) by the ledge 414 of the first support 406 to an increasing degree. Described another way, an increasing extent of the upper surface 418 of the filter module 300 is covered by the ledge 414. Simultaneously, the projection 422 of the filter module 300 first meets the first end 428 of the tapered engagement surface 424 of the clip 416. The projection 422 urges the clip 416 away from the upper surface 418 (e.g. in the x direction) by virtue of the increasing thickness of the clip 416 along the tapered surface 424 elastically deforming the clip 416. At the point where the projection 422 extends past the second end 428 of the tapered engagement surface 424, the projection 422 is received by the recess 430. As shown in FIG. 9, this is indicative of a locked configuration in which the filter module 300 is retained by the filter retention mechanism 402.

The invention is advantageous in providing a retention mechanism which both readily retains the filter module 300 in operation, but also provides a low force release mechanism by which the filter module 300 can subsequently be removed when needed for maintenance or servicing. As briefly mentioned above, during operation the filter module 300 is urged in a direction 420 (e.g. in the x direction) by virtue of comparatively high pressure fluid flow through the filter (through ports and connectors 442, 444, 446, 448). It is therefore necessary to retain the filter module 300 to protect the filter module 300 from being ejected by virtue of the fluid pressure. A challenge which is faced is that whilst the filter module 300 must be securely retained, the filter module 300 need also be removed intermittently in order to replace the filter for routine servicing. The present invention overcomes these issues by effectively providing a two-step retention mechanism by virtue of the ledge 414 and the clip 416.

The ledge 414 provides a generally axial retention (e.g. prevents the filter module 300 from being ejected in the direction 420/in the x direction) by virtue of at least providing a backstop functionality, and in some embodiments may abut the upper surface 418. The ledge 414 may be described as preventing the filter module 300 from moving to such an extent that the filter module 300 become disconnected from the plurality of ports in the second support 408. As previously mentioned, the generally arcuate upper surface 418 of the filter module 300 also creates problems by virtue of the filter module 300 being urged, or levered, away from the first support 406 in a direction that could lead to the filter module 300 being ejected, or de-coupling, from the first support 406. This is owing to the interaction between the domed upper surface 418 and the flat ledge 414. The inventors found that the incorporation of a single retention feature (e.g. such as the ledge 414) does not provide ample retention of the filter module 300 in operation. By advantageously incorporating the second retention feature (e.g. in the form of the clip 416), the filter module 300 is effectively secured in place and the upper surface 418 is substantially prevented from urging the filter module 300 away from the first support 406 (owing to the second retention feature rotationally latching the second support 408 with respect to the first support 406).

Furthermore, the clip 416 seeks to effectively rotationally latch the first and second supports 406, 408 together in a direction which differs from the urging direction 420 in which the filter module 300 is urged in operation. The clip 416 can therefore be readily detached by an operator, and the second support 408 and filter module 300 pivoted away from the first support 406, to allow for the filter module 300 to be readily removed from the filter retention mechanism 402. The invention therefore advantageously provides a generally axially retention (e.g. in the negative x direction) of the filter module 300, by virtue of the ledge 414, and also provides a rotational latch, in a different direction (e.g. about the x axis), which secures the first and second supports 406, 408 together, which can be readily released when needed to provide access to the filter module 300.

A further advantage is that, by virtue of the tapered engagement surface 424 of the clip 416, the clip 416 is effectively automatically engaged by the projection 422 of the filter module 300 as the filter module 300 (and second support 408) are rotated into the position shown in FIG. 9. The clip 416 therefore latches the retention mechanism 402 in the locked configuration as the mechanism transitions from the unlocked configuration to the locked configuration shown in FIG. 9. The clip 416 thus latches the mechanism 402 in the locked configuration as the second support 408 is urged, or rotated, towards the first support 406. The direction of retention by the clip 416 is therefore substantially perpendicular to the direction 420 in which the filter module 300 is urged in use.

Optionally, the retention mechanism 402 further comprises an ejection mechanism (not visible in FIG. 9) for ejecting the filter module 300 from the filter retention mechanism 402 (e.g. in the x direction). It will be appreciated that, in use, the filter module 300 may become somewhat stuck in connection with the second support 408. The ejection mechanism aids the removal of the filter module 300 after, for example, prolonged use. The ejection mechanism may take the form of a lever which, by virtue of mechanical advantage, increases the force exerted by an operator to remove the filter module 300. Alternatively, a screw arrangement may be used in which the filter module 300 is urged away from the second support 408. It will be appreciated that a variety of other ejection mechanisms may otherwise be employed. The ejection mechanism may be described as a filter ejection mechanism. The ejection mechanism may reduce the force required from an operator (to eject or remove the filter) to around 70 N.

Turning to FIG. 10, a cross-section side view of the assembly 400 shown in FIG. 9 is provided. Many of the features shown in FIG. 10 have already been described in connection with FIG. 9, and that description will therefore not be repeated here for brevity.

FIG. 10 shows the filter module 300 with a third port 452 received by a third female connector 446 of the second body 408. FIG. 10 also shows various features of the first support 406 including the ledge 414 and the clip 416 (including cut-out 432). FIG. 10 indicates a small gap (e.g. a clearance) 419 between the upper surface 418 of filter module 300 and the ledge 414. The gap 419 provides a clearance as the filter 300 and second support 408 are rotated, relative to the first support 406, into the locked configuration shown in FIG. 10. In use, the filter module 300 is urged outwardly by pressurised fluid flowing therethrough, which urges the filter module 300 into engagement with the ledge 414.

The relative alignment of the projection 422 of the filter module 300 with the recess 430 of the clip 416 is also shown in FIG. 10. The arcuate nature of the upper surface 418 of the filter module 300 is also shown. Alignment feature 456 of the first body 406 is also shown. When the retention mechanism 402 is in the locked configuration, the projection 422 of the filter module 300 is located between the alignment body 456 and the second end 428 of the tapered engagement surface 424.

An opening 454 in the first body 406 is also shown, with part of the filter module 300 being partly received therethrough in the region labelled 458.

FIG. 10 also shows the collar 441 comprises a cut-out 443. The cut-out 443 allows a magnet of the filter module 300 to be provided in closer proximity to a sensor which will be described in detail in connection with FIG. 11.

Turning to FIG. 11, a rear view of the assembly 400 shown in FIGS. 9 and 10 is provided. The rear view shows more details of the first support 406. For example, the opening 454 in the first support 406 is shown.

FIG. 11 illustrates that the retention mechanism 402 comprises a sensor 460, a magnet sensor (e.g. a hall effect sensor) in the illustrated embodiment. The sensor 460 is used to detect that the filter module 300 is correctly seated in at least the locked configuration shown in FIG. 11. Described another way, the sensor 460 determines that the filter module 300 is correctly positioned with respect to the second support 408 but also that the second support 408 is in the correct locked configuration with respect to the first support 406. The sensor 460 also determines that there is a filter module 300 present. The sensor 460 may detect the present of a magnet, provided on the filter module 300. The sensor 460 is advantageous over alternative detection mechanisms because, as well as detecting the position of the second support 408 relative to the first support 406, the sensor 460 can also detect the presence of a filter module 300.

FIG. 12 is a perspective view of the assembly 400′. The assembly 400′ corresponds to the assembly 400 shown in the earlier Figures save for a few minor differences (which will be described below).

The assembly 400′ is show in an unlocked configuration in FIG. 12. The filter module 300′ is thus receivable by the second support 408 in the illustrated position. The second support 408 is shown rotated away from the first support 406′ about the axis of rotation 410.

The filter module 300′ differs from the filter module 300 in that a projection 422′ of the filter module 300′ comprises apertures 423′, 425′. The apertures 423′, 425′ provide openings through which an operator can grip, and manipulate, the filter module 300′.

Unlike the first support 406, the first support 406′ shown in FIG. 12 does not comprise opening 454.

FIG. 13 is a perspective view of the filter module retention mechanism 402′ in an unlocked configuration. FIG. 13 shows the assembly 400′ of FIG. 12 in the absence of the filter module 300′.

FIG. 13 shows the second support 408 comprising the collar 441 coupled to the support member 440. The second support 408 further comprises first to third female connectors 442, 444, 446. First to third female connectors 442, 444, 446 are associated with a corresponding one port extending from the filter module.

The term retain as used herein comprises active engagement (e.g. abutment) and retention by way of a backstop/buffer which prevents movement of a component (e.g. filter module) past a retention feature (for example). Retention therefore does not require active contact, but may comprise active contact.

The upper surface of the filter module may otherwise be described as an outer surface. The upper surface of the filter module may otherwise be described as a surface of the filter module which opposes one or more ports (e.g. connectors) of the filter module.

Various modifications and alternatives may be provided to the above described embodiments. For example, whereas the filter modules described above are described in the context of a continuous inkjet printer, they may be provided separately. Such filter modules may be provided as a removable module of an inkjet printer. It will further be appreciated that while a particular form of ink system and continuous inkjet printer is described, the filter can be applied to different printer configurations. For example, the filter could be used in systems using non-pigmented ink, or soft-pigmented ink. Similarly, while an electrostatic deflection arrangement using two deflection electrodes to deflect a single jet of ink droplets is described, different forms of deflection may be preferred, e.g. using different numbers of deflection electrodes, and/or different numbers of droplet streams. Similarly, the filter could be used in printers that do not require a continuous jet of ink to be generated.

The above-described examples are intended to be illustrative in nature and are not intended to limit or define the scope of protection. The scope of protection is defined by the claims.

In addition to or as an alternative to the above, the following examples are described. The features described in any of the following examples may be utilized with any of the other examples described herein.

Example 1: A filter module for filtering ink, the filter module comprising: a filter housing defining: a filter chamber; an inlet port; a first outlet port; and a second outlet port; a first filter element, comprising a first filter media, disposed in the filter chamber; wherein: the filter housing is configured to define a first filtrate path from the inlet port to the first outlet port via the first filter element, and a second path from the first inlet port across an outer surface of the first filter element to the second outlet port; and when in use, the first outlet port and the second outlet port are arranged vertically above the inlet port.

Example 2: The filter module according to example 1, further comprising a second filter element comprising a second filter media disposed in the filter housing, the second path being a second filtrate path from the inlet port to the second outlet port via the second filter media.

Example 3: The filter module according to example 2, wherein the first filter element has a first absolute rating, and the second filter element has a second absolute rating different to the first absolute rating.

Example 4: The filter module according to any preceding example, wherein the filter housing is configured to define a third filtrate path from the inlet port to the second outlet port via the first filter media.

Example 5: The filter module according to example 4, wherein the third filtrate path passes through the first filter element for a first time to a central cavity surrounded by the first filter element, and then passes through the first filter element for a second time to an outer cavity surrounding the first filter element.

Example 6: The filter module according to any preceding example, wherein, in use, the filter is arranged to cause ink to flow in a generally upwards direction from the inlet to the first and second outlet ports.

Example 7: The filter module according to any preceding example, wherein, in use, the second outlet port is arranged vertically above the first outlet port.

Example 8: The filter module according to any preceding example, wherein, in use: flow of ink along the first filtrate path is in a direction generally opposite to the direction that gravity acts; and/or flow of ink along the second path is in a direction generally opposite to the direction that gravity acts.

Example 9: The filter module according to any preceding example, wherein the second path comprises a path defined between an outer surface of the first filter element, and a wall of the filter housing defining the chamber.

Example 10: The filter module according to example 3 or any preceding example dependent thereon, wherein the absolute rating of the second filter media is greater than the absolute rating of the first filter element.

Example 11: The filter module according to example 3, or any preceding example dependent thereon, wherein the effective surface area of the first filter element is greater than the effective surface area of the second filter element.

Example 12: The filter module according to any preceding example, wherein the first filter media is a pleated filter media.

Example 13: The filter module according to example 12, wherein the first filter element comprises a pleat protection filter, at least partially covering the pleated filter media.

Example 14: The filter module according to example 12 or 13, wherein the first filter element comprises an output screen, disposed between the pleated filter media and the first output port.

Example 15: The filter module according to example 14, wherein the absolute rating of the first filter element is defined by the output screen.

Example 16: The filter module according to any preceding example, wherein the first filter element defines a central cavity, and the first filter element comprises a central supporting structure, the central supporting structure being disposed within the central cavity.

Example 17: The filter module according to example 11 or any preceding example dependent thereon, wherein a nominal rating of the first filter element is defined by the pleated filter media.

Example 18: The filter module according to any preceding example, wherein the first filter element is generally cylindrical.

Example 19: The filter module according to any preceding example, wherein the inlet port, the first outlet port, and the second outlet port are arranged on a single face of the filter housing.

Example 20: The filter module according to any preceding example, wherein, in use, the flow rate of ink through the second outlet port is greater than the flow rate of ink through the first outlet port.

Example 21: The filter module according to any preceding example, further comprising a presence detection feature configured to interact with a detector configured to detect when the filter is engaged with a printing system.

Example 22: The filter module according to any preceding example, wherein the filter module further comprises a removal handle.

Example 23: The filter module according to any preceding example, wherein the filter module further comprises an engagement structure for engagement with a complementary structure of a printer to secure the filter module in an installed configuration.

Example 24: A continuous ink jet printer comprising an ink circuit, the ink circuit comprising an ink tank, an ink pump arrangement and a filter module for filtering ink according to any preceding example wherein the ink pump is configured to pump ink from the ink tank through the first inlet port to pass along at least one of the first filtrate path and second path.

Example 25: The continuous ink jet printer according to example 24, where, in use, the filter module is arranged to cause ink to be pumped in a generally upwards direction away from the inlet port.

Example 26: The continuous ink jet printer according to example 24 or example 25, further comprising a pressure sensor, the pressure sensor configured to sense the pressure drop across the first filter element.

Example 27: The continuous ink jet printer according to any one of examples 24 to 26, as dependent upon at least example 2, further comprising a pressure sensor, the pressure sensor configured to sense the pressure drop across the second filter element.

Example 28: A filter housing for a filter module for filtering ink, the filter housing defining: a filter chamber; an inlet port; a first outlet port; and a second outlet port; wherein: the filter chamber is configured to receive a first filter element; the filter housing is configured to define a first filtrate path from the inlet port to the first outlet port via the received first filter element, and a second path from the first inlet port across an outer surface of the received first filter element to the second outlet port; and when in use, the first outlet port and the second outlet port are arranged vertically above the inlet port.

Example 29: A method of manufacturing a filter module for filtering ink according to any one of examples 1 to 23, the method comprising: placing a second filter element comprising a second filter media having a second absolute rating in a second outlet port defined by a filter housing, the filter housing further defining an inlet port, a first outlet port, and a filter camber; and placing a first filter element, comprising a first filter media having a first absolute rating, in the filter chamber.

Example 30: The method according to example 29, further comprising forming the first filter element, the forming including: forming a pleated filter media with a central cavity; securing a first closure on to a first end of the filter media; and securing a second closure onto a second end of the filter media, which opposes the first end.

Example 31: The method according to example 30, wherein prior to securing the first and second closures, the method comprises: disposing in the central cavity, a central supporting structure; and surrounding an outer face of the pleated filter medium with a pleat protection filter.

Example 32: The method according to example 31, further comprising thermally welding the first closure and the second closure to pleated filter media.

Example 33: The method according to any of examples 30 to 32, wherein: the first filter element comprises an outlet port engagement arrangement and placing the first filter element in the main chamber includes engaging the engagement arrangement with the first outlet port; and/or the method further comprises, after placing the first filter element in the filter chamber, joining two parts of the filter housing together by spin welding.

Example 34: A method of filtering ink, the method comprising: pumping ink into a filter chamber defined by a filter housing via an inlet port; filtering, by a first filter element disposed in the filter chamber, a first portion of the ink flowing along a first filtrate path, the filtrate flowing out of the filter chamber via a first outlet port; causing a second portion of the ink to flow along a second path, the second path passing across an outer surface of the first filter element to a second outlet port; wherein, when flowing along the first filtrate path and the second path the flow direction of the ink comprises a component that is in a direction that is opposite to gravity.

Example 35: The method of example 34, further comprising filtering, by a second filter, the second portion of the ink.

Example 36: The method of example 35, wherein causing the second portion of the ink to flow along the second path comprises the filtering by the second filter, the second filter being disposed in the second outlet port.

Example 37: The method of example 35 or 36, wherein: filtering, by the first filter element comprises filtering the first portion of ink to remove particles above a first predetermined size; and filtering, by the second filter element comprises filtering the second portion of ink to remove particles above a second predetermined size, the second predetermined size being greater than the first predetermined size.

Example 38: A method of operating a continuous inkjet printer comprising the method of filtering ink according to any one of examples 34 to 37, further comprising pumping the first portion of the ink from the first outlet port to a printhead of the continuous inkjet printer.

Example 39: The method of operating a continuous inkjet printer according to example 38, further comprising pumping the second portion of the ink from the second outlet port to a Venturi pump.

Example 40: The method of operating a continuous inkjet printer according to example 38 or 39, further comprising pumping the second portion of the ink from the second outlet port to an ink tank of the continuous inkjet printer.

Example 41: A filter module retention mechanism for retaining a filter module for a continuous inkjet printer, comprising: a first support; and a second support pivotally connected to the first support; wherein the filter module is receivable by at least one of the first and second supports in an unlocked configuration in which the second support is distal the first support; wherein at least one of the first and second supports comprises a first retention feature configured to retain the filter module in a locked configuration in which the second support is proximate the first support, to retain the filter module; and wherein at least one of the first and second supports comprises a second retention feature configured to latch the mechanism in the locked configuration and substantially prevent rotation of the second support relative to the first support.

Example 42: The filter module retention mechanism of example 41, wherein the second retention feature is a clip.

Example 43: The filter module retention mechanism of example 42, wherein the clip comprises a tapered engagement surface.

Example 44: The filter module retention mechanism of any of examples 41 to 43, wherein the second retention feature latches the mechanism in the locked configuration as the filter module retention mechanism transitions from the unlocked configuration to the locked configuration.

Example 45: The filter module retention mechanism of example 44, wherein the second retention feature latches the mechanism in the locked configuration as the second support is rotated towards the first support.

Example 46: The filter module retention mechanism of any of examples 41 to 45, wherein the first retention feature comprises a ledge of the first support.

Example 47: The filter module retention mechanism of any of examples 41 to 46, wherein the at least one of the first and second supports, by which the filter module is receivable, further comprises a plurality of ports for connection to corresponding ports of the filter module.

Example 48: The filter module retention mechanism of example 47, wherein the plurality of ports comprises a plurality of female connectors.

Example 49: The filter module retention mechanism of any of examples 41 to 48, wherein, in use, a retention force, exerted by the first retention feature, is in a first direction, and wherein a retention force, exerted by the second retention feature, is in a second direction different than the first direction.

Example 50: The filter module retention mechanism of any of examples 41 to 49, wherein the filter module is receivable by one of the first and second supports in the unlocked configuration, and wherein the other of the first and second supports comprises a sensor configured to detect the filter module in at least the locked configuration.

Example 51: The filter module retention mechanism of any of examples 41 to 50, further comprising an ejection mechanism for ejecting the filter module from the filter module retention mechanism.

Example 52: The filter module retention mechanism of any of examples 41 to 51, wherein the second support is configured to receive the filter module in an unlocked configuration, and wherein the first support is a fixed support configured to retain the filter module in a locked configuration.

Example 53: The filter module retention mechanism of examples 52, wherein the first support comprises the second retention feature.

Example 54: An assembly for a continuous inkjet printer, comprising: the filter module retention mechanism according to any of examples 41 to 53; and a filter module retained by the filter module retention mechanism.

Example 55: The assembly of example 54, wherein the second retention feature engages a projection of the filter module in the locked configuration.

Example 56: A continuous inkjet printer comprising the assembly of examples 54 or 55. Example 57: The continuous inkjet printer of example 56, wherein the filter module is the filter module according to any of examples 1 to 23.

Example 58: A method of securing a filter module in a filter module retention mechanism of a continuous inkjet printer, comprising: urging the filter module retention mechanism into an unlocked configuration in which a second support is distal a first support; placing the filter module in engagement with one of the first and second supports such that the filter module is received by the one of the first and second supports; urging the filter module retention mechanism into a locked configuration, in which the second support is proximate the first support, by rotating the second support towards the first support, and retaining the filter module by a first retention feature of one of the first and second supports, and engaging a second retention feature of one of the first and second supports to latch the mechanism in the locked configuration and substantially prevent rotation of the second support relative to the first support.

Example 59: The method of example 56, wherein placing the filter module in engagement with one of the first and second supports comprises placing the filter module in engagement with the second support; and wherein urging the filter module retention mechanism into a locked configuration comprises: aligning the first retention feature of the first support with the filter module to retain the filter module, and urging the second retention feature of the first support into engagement to latch the mechanism in the locked configuration.

Example 60: The method of examples 58 or 59, wherein the second retention feature engages the filter module.

Example 61: The method of example 60, wherein the second retention feature engages a projection of the filter module.

Example 62: The method of example 61, wherein engaging the projection of the filter module with the second retention feature comprises urging a tapered engagement surface of a clip over the projection of the filter module to latch the mechanism in the locked configuration.

Example 63: The method of any one of examples 58 to 62, further comprising detecting, via a sensor, that the filter module is correctly seated in at least the locked configuration.

1. A filter module for filtering ink, the filter module comprising:
a filter housing defining:
a filter chamber;
an inlet port;
a first outlet port; and
a second outlet port;
a first filter element, comprising a first filter media, disposed in the filter chamber;
wherein:
the filter housing is configured to define a first filtrate path from the inlet port to the first outlet port via the first filter element, and a second path from the inlet port across an outer surface of the first filter element to the second outlet port; and
wherein the inlet port, the first outlet port, and the second outlet port are arranged on a single face of the filter housing; and
when in use, the first outlet port and the second outlet port are arranged vertically above the inlet port.

2-5. (canceled)

6. The filter module according to claim 1, further comprising a second filter element comprising a second filter media disposed in the filter housing, the second path being a second filtrate path from the inlet port to the second outlet port via the second filter media.

7. The filter module according to claim 1, wherein the first filter media is a pleated filter media, and the first filter element comprises an output screen, disposed between the pleated filter media and the first outlet port.

8. The filter module according to claim 1, wherein the first filter element is generally cylindrical.

9. The filter module according to claim 6, wherein the first filter element has a first absolute rating, and the second filter element has a second absolute rating different to the first absolute rating.

10. The filter module according to claim 1, wherein the filter housing is configured to define a third filtrate path from the inlet port to the second outlet port via the first filter media, wherein the third filtrate path passes through the first filter element for a first time to a central cavity surrounded by the first filter element, and then passes through the first filter element for a second time to an outer cavity surrounding the first filter element.

11-15. (canceled)

16. The filter module according to claim 9, wherein the absolute rating of the second filter element is greater than the absolute rating of the first filter element.

17. The filter module according to claim 9, wherein an effective surface area of the first filter element is greater than the effective surface area of the second filter element.

18. The filter module according to claim 7, wherein the first filter element comprises a pleat protection filter, at least partially covering the pleated filter media.

19. The filter module according to claim 7, wherein an absolute rating of the first filter element is defined by the output screen.

20. The filter module according to claim 1, wherein the first filter element defines a central cavity, and the first filter element comprises a central supporting structure, the central supporting structure being disposed within the central cavity.

21. The filter module according to claim 7, wherein a nominal rating of the first filter element is defined by the pleated filter media.

22. The filter module according to claim 1, further comprising a presence detection feature configured to interact with a detector configured to detect when the filter is engaged with a printing system.

23. The filter module according to claim 1, wherein the filter module further comprises a removal handle.

24. The filter module according to preceding-claim 1, wherein the filter module further comprises an engagement structure for engagement with a complementary structure of a printer to secure the filter module in an installed configuration.

25-28. (canceled)

29. A filter housing for a filter module for filtering ink, the filter housing defining:
a filter chamber;
an inlet port;
a first outlet port; and
a second outlet port;
wherein:
the filter chamber is configured to receive a first filter element;
the filter housing is configured to define a first filtrate path from the inlet port to the first outlet port via the received first filter element, and a second path from the first inlet port across an outer surface of the received first filter element to the second outlet port; and
when in use, the first outlet port and the second outlet port are arranged vertically above the inlet port.

30. A method of manufacturing a filter module for filtering ink, the method comprising:
forming a first filter element, the forming including:
forming a pleated filter media with a central cavity;
securing a first closure on to a first end of the filter media; and
securing a second closure onto a second end of the filter media, which opposes the first end;
placing a first filter element, wherein the first filter media has a first absolute rating, in the filter chamber.

31. The method according to claim 30, further comprising,
placing a second filter element comprising a second filter media having a second absolute rating in a second outlet port defined by a filter housing, the filter housing further defining an inlet port, a first outlet port, and a filter chamber.

32. The method according to claim 30,
wherein prior to securing the first and second closures, the method comprises:
disposing in the central cavity, a central supporting structure; and
surrounding an outer face of a pleated filter medium with a pleat protection filter, and
wherein the method comprises:
thermally welding the first closure and the second closure to pleated filter media.

33. (canceled)

34. The method according to claim 30, wherein:
the first filter element comprises an outlet port engagement arrangement and placing the first filter element in the main chamber includes engaging the engagement arrangement with the first outlet port; and/or
the method further comprises, after placing the first filter element in the filter chamber, joining two parts of the filter housing together by spin welding.

35-63. (canceled)
